(19) United States
(12) Patent Application Publication
(10) Pub. No.: US 2018/0350477 A1
(43) Pub. Date: Dec. 6, 2018

(54) System and Methods for Nuclear Waste Conversion into Non-Radioactive State

(71) Applicant: Eric Arno Vigen, Calabasas, CA (US)

(72) Inventor: Eric Arno Vigen, Calabasas, CA (US)

(21) Appl. No.: 15/615,822

(22) Filed: Jun. 6, 2017

(51) Int. Cl. G21F 9/00; G21G 1/04; G21F 9/28

(52) U.S. Cl. CPC G21F 9/00; G21Y 2002/60; G21F 9/28; G21G 1/04

(57) ABSTRACT

The systems with a combination of a) methods to orient and/or stabilize the radioactive material to a magnetic axis and b) a delivery or reflection method of particles at a specific angle relative to the induced orientation to improve the penetration of said particles past the electrons shell into the nucleus for nuclear decay at a rate faster than the standard half-life calculations or similar reflection methods and systems to redirect decay-expulsion particles back at the preferred angles that increase the target material decay rate. Includes methods of pre-preparation of material, and in production use to extend useful periods of materials such that disposal of used materials deeper in their life when it is already less radioactive.

### REFERENCED PRIOR ART

U.S. application Ser. No. 15/245,326 Vigen
U.S. application Ser. No. 15/256,865 Vigen
U.S. application Ser. No. 15/490,870 Vigen, et al.
U.S. Pat. No. 4,051,429 Inanari, et al.
U.S. Pat. No. 5,020,411 Rowan
U.S. Pat. No. 4,018,012 Hopkins
U.S. Pat. No. 4,662,124 Kato

For this filing, I, Eric Arno Vigen, declare that no federal funds were used in its development.

### BACKGROUND OF THE INVENTION

The challenge of nuclear decay, radioactivity, or other changes to atoms flows from the natural atomic structures with a nucleus surrounded by electrons. This electron natural barrier stops external particles, like protons and neutrons, from changing an atom's nucleus particle count. In most molecules, this makes an atom, once build, very stable. However, in atoms of large nucleus particle count, a percentage of the them have an ejection, specifically for the present invention radioactive ejections with related radioactivity. For radioactive elements, nucleus particles eject often enough a) that some pass other atom's electron shell barrier, and b) those trigger other atom's nucleus particle injection which in turn ejects another set of particles in an unending chain that can last millions of years. That radioactive radiation has both value and risks. Either the radiation can have uses of the radiation for power plants or medical diagnosis, or the radioactivity can cause mutation, organ illness, and even death.

At issue in the present invention is changing that radiation rate, especially in spent radioactive fuel, and the conversion of radioactive materials into non-radioactive material by access to those unconverted nucleus. Any process getting to the nucleus is exponentially difficult because the exterior electron ‘shell’ protection of one atom usually sits with a similar external electrons shell. In normal atoms, it is exponentially more difficult because both atoms have the protective electron shells. In that manner, without human processes, changes of atom's nucleus is rare. Radioactivity itself is rare.

For the purposes of commercial uses herein, the nucleus structure will remain a stable structure unless another nuclear particle (neutron or proton) changes the system, yet when the number of protons is very high any natural trigger begins the material regularly to eject these dangerous particles at a rate such that the next atom gets a particle to maintain a chain reaction of decaying, called radioactivity. In Elements after 082-Pb-Lead and 083-Bs-Bismuth, one electron ejection usually causes the next atom, in a chaining reaction, to absorb a particle, reduce the nucleus particle count by then re-ejecting even more particles. When such ejected particle hits living organisms, it can cause genetic mutation, and in heavy doses, radiation can cause organ illness, failure, and even death. The reduction of radioactive material to stability, and immaterial levels of radiation, is a critical requirement for society as well the companies that utilize radioactive material commercially, including medical, industrial and military institutions. And today there are tons of these dangerous materials simply buried because no commercially viable radioactivity reduction process exists. This filing and the present invention shall focus on one such various embodiments of the present invention to address that serious problem. The present invention focuses on this type of nucleus change, and does not address the other observed non-radioactive Element nucleus changes, including observed neutron particle decay. That type is not involved with the present invention, and not necessary to discuss in the present invention Background.

The rate of those ejections and re-injections in chains naturally is very small for Periodic Chart Elements until 084-Po-Polonium which decays at a half-life of about 102 years, and decay rates vary up and down the Periodic Chart of those radioactive Elements in which Element 092-U-Uranium at a special configuration which decays at a half-life of over one billion (1,000,000,000) years, and 087-Fr-Francium is only 1,302 seconds. A half-life is the time it takes for the half of the material to change from a high-Atomic Number element into a lower-proton-count Atomic Number element. The mathematics of the remaining material is determined with a factor in its exponent of the time elapsed. The base under that exponent is the ejection-re-injection-decay rate. The amount of unconverted material, the number of such atoms, decreases the decay rate over time as less material is radioactive—because the percentage of the material already changes decreases leaving less and less radioactive materials. The half-life is a scientific naming choice of an even longer decay process.

In each decay interaction proposed beyond the natural radioactive ejection-re-injection process, external nucleus particles, neutrons and protons, penetrate to the nucleus of the high Atomic Number atom. The basics of particle injection into atoms is known prior art. So, there are known injections to increase the Atomic Number of the material or decreases to reduce the Atomic Number.

So, in some cases, that injection works to increase nuclear particle count. That is how scientists, in prior art, have created the synthetic elements 093-Np-Neptunium to 118-Og-Oganesson by shooting neutron-proton bundles at a nucleus, and occasionally, after penetrating the electron shell, those bundles stick for a change (increase) of the atom's nucleus, and thereby the atom, with its half-live, of the new element. Only this injection process seems to change a nucleus in prior art to date. Without injection, these elements (093-Np to 118-0g) are not naturally occurring. It is a special case to get a nucleus to increase in proton count (Atomic Number), but it can occur. The use of the present invention to improve this prior art process by delivery of multiple atom groups, versus a single particle, gets covered in Claim 13.

Yet, the particle injections for reduction, their paths, and their frequency, are the focus of the main present invention. In the same way, when external particles hit the nucleus, more often that interaction creates a realignment which pushes a neutron out of the way, and leaves two protons too close to each other, and viola, powerful electrostatic force at extremely small distance (1/distance-square) between protons, such that the protons, often with some nearby neutrons or other protons, get expelled, or ejected. Given the strength of electrostatic repulsion proton to proton as such small distances, the acceleration and speed of the ejected particles is high. That expulsion particle stream is measurable (Geiger) in radioactive materials.

So, by external nucleus particles, entering a radioactive material nucleus and ejections triggered thereby in chains, 094-Plutonium reduces to 090-Radium, and 090-Radium reduces to 086-Rn-Radon, then to 084-Po-Polomium, and finally to a stable, non-radioactive 082-Pb-Lead. At each step, some protons (usually two or four) and related neutrons (usually at least as many as the protons) get expelled from the nucleus.

For the element 094-Pu-Plutonium, which is one of the present invention targets and major material in nuclear waste, has a half-life is E+7 years, 10,000,000 years. Effectively that is forever. However, an increase in the decay rate of 30× would change that half-life to 9.4 years. Further, if the increased ejections create further injections at that accelerated rate, that half-life is less than one year. That is the beneficial mathematics of exponential decay; a change in the rate exponentially changes the results because small changes compound and magnify over time.

Important to the present invention and the key challenge not addressed of prior work on the same challenge, the set of electrons around a nucleus in a ‘shell’ provides a barrier to these particles interactions. That is, at all ranges, the electrons in their field or ‘subshells’ repel each other by electrostatic charge. That electron-electron electrostatic repulsion makes atoms remain themselves as the outer shells repel the outer shells of other atoms. Atoms thereby bump off each other in substantially all situations. Further, those build for the radioactive elements of six or seven layers making the ability to penetrate substantially more difficult.

The approach of a neutron or proton, without electrons is already rare in nature. There are a few alpha or gamma particles observed in nature, but those were found as a few dots over extended exposures of X-Ray film. None of those are sufficient in frequency for commercial purposes. All such processes that would be commercially viable are developed by humans. That portion is a human-directed mechanical method for purposes of the present invention.

Geometry and Mathematics of AVSC

For reference, from my prior filing, a definition of newly created terms based upon my prior invention is required, in order to understand the present teachings and present invention:

1) NUCLEOMAGNETICS: Nucleomagnetics is the standing, permanent oriented force of subatomic particles under the teachings in my prior filings (15/256,865, 15/490,870) utilizing the Arno Vigen Scrunched Cube Atomic Model. This force decreases by 1/distance-cubed between the particles involved in the calculations. The strength increases in relation to the number of particles with nucleomagnetics, which takes into account both the protons and neutrons in the nucleus of the atom or compound along with any related electrons. That is a particle's strength times the total number of particles involved times each particle's strength combined. The constant of the nucleomagnetics force is the opposite sign of electrostatic charge force. Unlike motomagnetics, (the commonly observed) macro-world related force defined below, nucleomagnetics forces are repulsive between nucleus-to-electron in both hemispheres, and attractive between nucleus-to-nucleus particles. Specifically, the force strength of the field varies by a factor of an integral including the cosine of the inclination angle relative to the particle's axis. This factor is the exposed surface integral of the particle, which in a simplified version can be expressed by (1+3 COS ̂2)̂(½).

MOTOMAGNETICS: Motomagnetics is the magnetics created by the movement of particles, especially in defined directions for multiple particles. The relay of magnetic energy from particle to particle as passed causes their nucleomagnetics fields to rotate which changes and/or pulses their strength in various directions. Motomagnetics with repulsion depending on like pole north versus south, and repulsion de-pending on opposite pole attraction is the “magnetic” macro-world of moving particles, the commonly observed form of magnetics.

NUCLEOMAGNETIC AXIS: For a particle or group of particles, such as the nucleus, the magnetic field is aligned in one direction along an axis and its opposite at 180 degrees opposed to the first axis, relative to that particle group, which accounts for its relatively weaker nucleomagnetics strength as is the case with the atoms of Hydrogen and Helium in the Periodic Table of Elements. In other calculations relative to the inclination angles with the nucleomagnetics axis in the teachings, the strength increases as the angle to that axis increases, according to the surface integral factor. By the right-hand rule, a magnetic axis may be created by particles in rings or other structures, at an angle perpendicular to the ring or structure.

EQUATORIAL: Once a nucleomagnetics axis is established, there becomes an equatorial inclination/longitude which at an inclination angle of 90 degrees to both poles of that particle group's nucleomagnetics force is also the strongest position (at the same distance) of the nucleomagnetics forces. Normally, (by conventional wisdom of motomagnetics observations), that would not be the lowest energy motomagnetics placement (or settling position) for electrons, yet the first three electrons of many sub-shells, and the equatorial subshell position of just one electron, or two electrons at 0 degrees and 180 degree positions of latitude from each other, or in the case of three electrons at 0 degrees, 120 degrees, and 240 degrees latitude from each other occurs as the lowest, energy, stable state in my prior filing herein disclosed.

NUCLEOMAGNETICS ANGLE: The angle between and the electron position or bonding position relative to the nucleomagnetics axis with the nucleus as the vertex.

BONDING ANGLE (According to the AVSC model) is the bonding angle between two bonding positions with the nucleus as the vertex.

NUCLEOMAGNETICS CONSTANT: For some calculations under the AVSC Model, the number of particles in each group, say contained in the nucleus (for example) in a group times the electron of one, is the constant. This comprises the gross strength before accounting for the inclination angle factor in the computation.

REDUCED NUCLEOMAGNETIC-ROOT CONSTANT: As the basis of the nucleomagnetics constant is the principal that a particle (either Proton, Neutron, Electron) has a magnetic strength. While for convenience, we teach the example of multiplying the particles in two groups, then multiply that product by the nucleomagnetics constant, the preferred constant which is required for other similar calculations of the two particles sets using the Square-Root of that constant, then multiplying those products by each other. This calculation is similar to that of the Planck constant and the Reduction-Planck logic, which is well understood and documented. Most people were taught that protons and electrons attract, by that same electrostatic force law, Coulomb's Law, but not the Newtonian opposite force of the present invention AVSC teaching.

The teachings of the present invention and my prior filings (15/490,870) is that the electron-proton interaction is the balancing of electrostatic versus nucleomagnetics forces; there are two forces with different shapes and strength profiles. Both are inherent in different ways in the known particles. Electrostatic charge is spherical and decreases at 1/distance-squared. Nucleomagnetics force reduces the faster rate of 1/distance-cubed, with a strength change based upon the inclination angle of the one particle relative to the nucleomagnetics axis of another particle.

Yes, at long distance, at 1/distance-squared for electrostatic versus 1/distance-cubed for nucleomagnetics makes the attraction of electrostatic much greater, so objects are attracted. At large distances, that combined force, because the nucleomagnetics changes by 1/distance-cubed, expresses as effectively the same as electrostatic charge force alone. At a distance, nucleomagnetics is immaterial to the calculation of force. That is the reason that few, if anyone but me, have focused on nucleomagnetics until my prior filings. The nucleomagnetics force is immaterial at distances beyond a few angstroms as it decreases exponentially faster. Yet, at subatomic distances, the electrons are repelled by nucleomagnetics more powerfully than the electrostatic charge force (attraction). That is the other end of 1/distance-cubed. At subatomic distances, that 1/distance-cubed force becomes the strongest. For example, at a distance of 1/2 the balancing point (Bohr) nucleomagnetics 1/distance-cubed (1/((½)̂3)=8 actually is greater than electrostatic 1/distance-squared (1/((1/2)̂2)=4. So, electrons repel from both protons and neutrons by a nucleomagnetics force, as discussed in my prior filing (15/490870). Approaching neutrons or protons are repelled by this electron-proton nucleomagnetics repulsion before reaching the nucleus. This 2^{nd} level of repulsion at or inside the nuclear distances, balancing at a derivative of Bohr radius, is why the vast majority of materials in the universe remain as a same stable Element, with a nucleus of the same, stable Atomic Number, without change and with electrons in ‘shell’ settling positions relative to the nucleus and its nucleomagnetics axis according to my prior filing. The ‘settling’ is the place, the nucleomagnetics angle and the radius distance, of balance between nucleomagnetics and electrostatic force for the set of particles. The nucleus is protected even if free protons or neutrons exist nearby. It is my prior filing (15/490,870) teachings related to the present invention that:
Even though traditional electrostatic theory states that an electron shell would attract free protons, opposites attract at a distance.
At subatomic distances, the nucleomagnetics repulsion is larger, even exponentially larger keeping free protons or neutrons from passing into or past the electron shell, and joining the nucleus to change the atom from one Element to a different Element. AVSC teaches that electrons net repel both protons and neutrons beginning at about the Bohr radius, depending upon the angle.

Even if electrons, by electrostatic charge force, get attracted to nucleus protons, its Newtonian balance opposite, electron-nucleus nucleomagnetics repulsion forces creates a standard distance, essentially the Bohr radius outside the outer electron shell, where electrons stay in the shell and any protons stay beyond that shell by another Bohr radius. Thereby, free protons do not fall in mass into the nucleus, or importantly herein, do not fall into the electron shell. That balancing of electrostatic and nucleomagnetics is the basis of the ‘weak force’, and further leads to the electron positions, distances, bonding angles, and even quantum mechanics. See the prior filing for extensive details on those teachings required as part of the present invention.

The discovery and teaching of the present invention and my prior filing (U.S. Ser. No. 15/490,870) is that the electrons have settling positions relative to each other, and relative to the nucleus and its nucleomagnetics axis. Further, the nucleus and electrons move and rotate as a relative group except for separate movement harmonics of quantum mechanics whereby the particles bounce between the forces of surrounding particles, particularly getting unsettled by nearby electron movements, and then re-settle back into harmony.

So, for purposes of the present invention, that protective layer is six or seven layers thick. That is the number of electrons shells known in the radioactive materials that are the target in the present invention.

Background on Subshells Settling Angles

As described in my prior art filings, the combination of electrostatic attraction versus nucleomagnetics repulsions creates a separation of the nucleus from electrons. Further, because nucleomagnetics have that shape based of changing force based upon the inclination angle relative to the nucleomagnetics axis, and equal force at the same inclination (longitude) angle for all latitudes (azimuth) angles, electrons have sets of different distances for this balance. Those are subshells in two hemispheres growing from one (1), to three (3) in each hemisphere, to five (5), and to seven in each hemisphere for the target radioactive atoms of the present invention. That makes subshells 2 hemispheres by the count around the geometry. That is, 2×1, 2×3, 2×5, and 2×7. Traditionally, they have been called Subshell-‘s’ (2×1=2 electrons max), Subshell-‘p’ (2×3=6 electrons max), Subshell-‘d’ (2×5=10 electrons max), and Subshell‘f’ (2×7=14 electrons max). However, given my prior art AVSC teaching know the geometry, the inclinational angle, deterministic forces, and structure, the subshells are re-named in AVSC as Subshell-m (2×1) because it settles on the nucleomagnetics angle, Subshell-‘c’ ‘f’ or ‘t’ (2×3) because the layer of three (3) sits either at the corners (‘c’) of a cube, the faces (‘f’) of the cube, or in a tight endcap (‘t’), and the outer subshells towards the equator to continue alphabetically as Subshell-‘u’ (2×5) and Subshell-‘v’ (2×7).

Finally, because, in my prior filing teachings, the electron—electron relationship has electrostatic repulsion does not have the balancing nucleomagnetics attraction, electrons do not bond, and also maintain settling position where each electron remains separate. Please note that I have not determined scientifically yet if the electron-electron interaction provides either a) no nucleomagnetics or b) a repulsive nucleomagnetics force. (That scientific distinction for my future work is not necessary for the Claims of the present invention.) I have tested and proven only that electron-electron nucleomagnetics force is not attractive. As such, electrons are always repelled from each other at all distances. By the way, that is a further reason why scientists failed to identify the nucleomagnetics force as it also remains unimportant to all current uses of electrons to electrons, including electrical resistance and electron behavior in ionization.

As depicted in FIG. 10, I have shown how the subshells sit in 2D. They build in sets from the nucleomagnetics axis, a zero (-0-) nucleomagnetics angle, to three (3) in smaller shells. As the subshells grow, then the outer subshells for radioactive Elements in each hemisphere grow from one (1) near the axis, to three (3), to five (5), to seven (7) near to the equator.

Yet, that representation in 2D is difficult. You can see that this view has some locations where electrons are front and back. This Figure shows two or three as a group at one distances and angle. However, these three are, in reality, separated in front and back or at space around the latitude positions at the same inclination/longitude. You can see some of the drawing in color in 3D in my prior art filing. For radioactive materials, FIG. 7 depicts that, at the equator (90 degrees) inclination (longitude), no subshell electrons exist, and the nearest electron subshells sit at a balanced angle. This gets applied in Claim 2.

Current scientific thinking operates in an entirely different paradigm.

The original thinking of electrons is orbits, Bohr-Rutherford, has electrons moving. However, my AVSC teachings only have electrons in settling positions moving or rotating as a group. In that way the electrons can orbit around the nucleus, yet still keep their relative settling positions in the group in the rotating frame of reference. In this way, AVSC address the orbit observation of Bohr-Rutherford, yet maintains its AVSC settling position postulate.

In the last 100 years, the scientific community has concentrated on electrons in statistical clouds. Quantum mechanics focused on the interaction of the electrons for radio radiation spectrum, harmonics, and bonding strength. Yet, quantum mechanics does not predict specific locations or angles or structure for the nuclear particles of a particular element. In AVSC, the electrons settling creates distances and multiple forces, both electrostatic and nucleomagnetics, that create both electrostatic and nucleomagnetics forces moving another particle in the set as one particle gets changes. In this way, AVSC address the harmonics observations of quantum mechanics, yet AVSC maintains its settling angle, distance, and position postulate.

Further, in Pauli exclusion, the electrons operate in pairs, including bonding. In AVSC, electrons would tend to settle in 3D locations exactly opposite each other. In this way, AVSC addresses the spin observation of Pauli and others, yet AVSC maintains its 3D settling position postulate. This has significant application for all bonding creating three types of bonds in my AVSC atomic model with 3D geometry and deterministic force vectors, instead of current two options only for bonding of covalent or ionic in Pauli pairs only. Application of those AVSC features are not required for the current invention, and will get left to another patent application in progress by me. In this way, AVSC address the Pauli exclusion and spin, yet AVSC maintains its settling angle, distance, and position postulate.

That mathematical calculation, by my prior filing, of the angles relative to each atom's nucleomagnetics axis is the fundamental Claim of the present invention. It is the science that provides the basis why the systems and methods from Claim 1 onward operate successfully. FIG. 6 and FIG. 7 depict visually how the AVSC model determines one preferred set of angles in Claim 2.

The concept of ‘1/2 spin’, used in calculating nuclear decay rates, initially discussed in my prior filing AVSC calculations (U.S. application Ser. No. 15/490,870), is a stable atom of an Element having one electron in one hemisphere without a corresponding electron in the opposite position has critical application to the present invention. It is the odd-numbered elements, like 91-Pa-Proactinium versus 92-U-Uranium. Spin creates a negative charge in one side of the element. As such, all 1/2 spin, odd elements have an electrostatic dipole. There is a direction with more negative charge versus positive charge, even though the proton and electrons are in balance (91 and 91). The orientation has the extra electron as the only-one-hemisphere filled inclination for a negative charge, and the extra proton in the nucleus as a positive charge. There is a permanent electrostatic directional difference.

The prior art connected these an electromagnetic dipole moment. However, in the teaching of the my prior art and the present invention, the inclination of that extra electron may not be on the nucleomagnetics axis. It may match; in the case of, 87-Fr-Francium, which, in the Shell-7 has only one electron, 7m1, which settles on the nucleomagnetics axis, this electrostatic dipole is the same as the nucleomagnetics axis. However, for 91-Protactinium, the extra electron is about 26 degrees off the nucleomagnetics axis. As such, 91-Protactinium does get good alignment, but not the near perfect of 87-Fr-Francium. However it is important to note that alignment of an inclination/longitude in multiple atoms does not align the latitudes, and thereby the nucleomagnetics axis can get in a range of azimuth (latitude) even if the bonding is electrostatic aligned by a nucleus-electron axis. As such, the other odd-count radioactive Elements do not express super-fast decay (compare 87-Fr-Francium—a half-life of 1,302 minutes being must shorter than 85-At-Astatine—29,106 minutes 89-Ra-Radium—87,197 minutes, or 91-Pa-Protactinium 118,000,000 minutes), yet the odd-count do exbit faster decay than the even-count Elements. That is strong evidence that supports the teaching of the present invention in that odd-count elements, where electrons settling calculated by my prior filing (15/490,870) is not on the nucleomagnetics axis like 087-Fr-Francium, have less decay, and its longer half-lives, and nucleomagnetics is a driving factor in that scientific difference. This natural process compares to the human induced process in Claim 10 where a electrostatic preference creates excellent nucleomagnetics for certain Elements, crystals of Elements, or similar methods.

It is the teaching of the present invention that the nucleomagnetics alignment is powerful in changing the decay rate, and thereby half-live, versus the natural standards. In fact, natural alignment actually does change the decay rate.

As depicted in FIG. 13, the half-life of 87-Fr-Francium, is the shortest of all radioactive elements. It has a half-life of 1,302 seconds, versus 5,732,766 seconds for 088-Ra-Radium or 13,788 seconds for 86-Rn-Radon, the two elements on either side in the Periodic Chart. The scientific observation is one of the key indicators that nucleomagnetics alignment is significant to decay rates.

Specifically, the decay rates of Elements that have one-hemisphere-only electron filing (‘1/2 spin’) are not all the same. In fact, only the one that aligns on the nucleomagnetics axis, per my AVSC teachings, has the amazingly short half-life. The other odd-elements that are radioactive, with half-life shorter than their neighbor even-Atomic Number Elements, and thereby that align by electrostatic dipole, but for electrons at an inclination angle different that the nucleomagnetics axis. So, their decay does not get that immense boost of full nucleomagnetics alignment where ejected path angles match the injection path angles of 087-Fr-Francium.

Therefore, the science conclusions of the teachings of my prior filing and the present invention are:
Any alignment of multiple radioactive nucleomagnetics axis increases the decay rate strongly, and thereby decrease the half-life strongly (91-Pa-Protactinium E+08 half-life versus 90-Th-Thorium E+13 and 92-U-Thorium E+13, so the increase is E+5 or 100,000×)
Full alignment of both electrostatic and nucleomagnetics has even strong impact on decay rates, and reduces half-live to the highest decay rate (and lowest half-life) of all naturally occurring radioactive elements (87-Fr-Francium).

However, before the teachings of my prior filings and the present invention, the scientific community focused on the electrostatic feature, and even called it ‘electromagnetic’ (see [0037]) to further make understanding almost impossible mixing the different force structures as if one. It is the teachings of the present invention, that electrostatic and nucleomagnetics are different forces, with difference profiles of expression. However, because both start from combinations of the same particles, protons, neutrons and electrons, the two are highly interlinked. Neutrons express only one of the forces, nucleomagnetics, and electrons only express the electrostatic repulsion without a magnetic attraction. Therefore, changing electrostatic features, can change the particles which thereby changes nucleomagnetics. The two are intertwined fundamentally.

The teaching of the present invention is a radical departure from any prior art as to the basic science underlying the basic atomic particles, and the fundamental forces of nature. The present invention is just one set of embodiments and use of the nucleomagnetics calculation of my prior art and the present invention. The present invention delves deeper via the multi-atom nucleomagnetics alignment (versus electrostatic dipole), and applications of methods based upon the determined nucleomagnetics axis and inclination angles determined from it.

Background on Nucleomagnetics Orientation

The closest prior art is NMR which uses a combination, including magnetics, as a method to orient and stabilize atoms such that measurement of bonding distances for various bond lengths of a compound molecule can occur. Its goal is to get the particles of an atom not moving at all, so the particles distances can get measured by radiation harmonics. The magnetics align them so the measurement of multiple atoms all express in one direction so the measurements are linear and additive. NMR uses the name magnetic, but magnetics is just a way to get close to no movement, zero Kelvin; the NMR embodiments relate to the harmonics of different bonds in molecules in one dimension, the ‘z’ dimension. It does not have the repulsive towards both poles of my prior art (Ser. No. 15/490,870) or the application of particles at angles of the present invention.

The NMR alignment process has challenges. The coldest temperature in use at present only get to 8 Kelvin, and gets used in NMR. However, that is not quite zero Kelvin (no movement). In NMR, the purpose and use of the strong magnet is to get the particles not moving in two of three directions (called ‘x’ and ‘y’ with ‘z’ being my nucleomagnetics axis direction for standardization throughout this filing). If NRM cannot get zero Kelvin, it, at least, isolates the movement to only the ‘z’ magnetic axis direction. At any temperature above zero Kelvin, the atomic set continues to move. However, by the addition of a very strong magnetic, that slow movement gets pressed, like a spinning top, only along the magnetic axis. In that manner, the movement is only around the ‘z’ magnetic axis direction. Further, any remaining movement is consistent based upon the strength of the magnetic field applied. The application of traditional magnetics field to achieve better nucleomagnetics alignment in the present invention is part of Claim 5.

Further, and important background to the present invention, because NMR uses a solvent, the material can move in any direction. In the case of NRM, that movement becomes twisting until it has magnetic alignment. Without the liquid feature, different layers of a solid would have different orientations, such that all particles would not create the same expressed profile. That the present invention target radioactive material is solid is a difference, and addressed by the various Claims of the present invention.

So, the NRM method requires a) cold temperature, b) very strong magnet, c) non-expressing solvent, and d) radiation generation and measurement. It does not have the added feature of particle delivery of the present invention. Further, here and my prior art describes the mechanics and science why and how NMR works better than the inventor's filing.

Further, for the purposes of the present invention, the use of the non-expressing solvent, required in NRM, creates a secondary challenge of its disposal. In that manner, one of the features of NMR prior art likely cannot apply to the present invention. That makes NRM excellent background, yet not the same. The science, when understood by using my AVSC atomic model, has similarities in both forces and processes. Both are based upon science closer to my AVSC postulates in the teaching of my prior art and the present invention. As such, the present invention does not require near zero Kelvin, as required for NMR.

Background on Material Preparation

The present invention focuses on material of solid rods. However, a solid rod has millions of layers of particles that are laying as best they can. That means the material generally is not aligned by nucleomagnetics. At that range of layers, getting sufficient alignment remains a huge challenge. We will discuss various areas to address that challenge, to reduce the number of layers or to assure that layers self-align.
Reduction of the size of particles by grinding, slicing, and similar techniques
Reduction of the size of particles by dissolving into a solution, probably with strong pH
Pre-preparation of the material by magnetic alignment into crystals or at least magnetic aligned solids
Partial alignment, and secondly sequential partial alignment, by applying magnetic field to the solid, or for 1/2 spin elements, applying an electrostatic charge field which then aligns nucleomagnetics.

Grinding is a method to reduce the size of materials. The original patents on grinding start with Dickinson in 1945 and from searches limited to 1975 forward start with Hopkins (U.S. Pat. No. 4,018,012) and continuing to thicknesses of 350 microns (3.5E-4 meters) in Kato (U.S. Pat. No. 4,662,124). However, a radioactive molecule is in the range of 10 Angstroms (E-9 meters). This compares to techniques that Claim E-5 to E-6 meters of material after grinding in a search of current providers. That means there are at least one to ten thousand (1,000 to 10,000) (E+3 or E+4) layers of molecules in fine ground solid by current models. Even when applying the reduction, the number of layers will have orientations as a solid diverse. As such, grinding is not the preferred embodiment of the alignment method.

For one of the most likely use, energy production, the dissolving process already occurs for other material preparation reasons. As such, the dissolving is a) already in service, and b) reduces material to singular atoms or a few atoms in combination. Claim 9 includes the live integration with production uses of radioactive material of the present invention. Claim 1 is the use either before, during or after without specification.

For enrichment, nuclear fuel already is dissolved, and then a centrifuge is used to segregate U235 from U237, the lighter from the heavier materials. After that, the separated, high-value material is dried (solvent removed) before actual production use. Therefore, including the Claims of the present invention as an added method and system with the existing process is the most natural course. The cost is already being incurred.

In the third option, magnetic alignment during dissolve/drying, the present invention does not change the dissolving process or the drying, or the enrichment process. However, the present invention can get applied in the drying process. Instead of simply drying the radioactive material, by the use of a) seed crystals and/or b) a strong magnetic during the drying process (or electrostatic charge field if the radioactive material has a 1/2 spin electrostatic dipole to drive the magnetic alignment). There are documented in Claim 15 and Claim 16.

The challenge in application for the electrostatic procedure is that the target Element is often 092-U-Uranium, which is not 1/2 spin. Therefore, electrostatic methods of nucleomagnetics alignment are not likely effective; there is no unbalanced electrons, so that options will be ineffective.

Further, 092-U-Uranium does not have electrons in a stackable structure. The outer shell has six electrons filled 7m2:2,7t4:6, in AVSC (7p2,6d4 in the prior art nomenclature). That is geometric not as likely to align because:
With only the Subshell-m and Subshell-t having electrons, the atom has an elongated shape. Atoms solidify with that extra part causing stacking that is not even.
With only a partial set of electrons in the subshell, atoms, incomplete in Subshell-7t, are further stacked unevenly. This is especially noticeable in the 2×(1 of 3) Subshell-7t, 090-Th-Thorium, which has the lowest rate of decay, and longest half-life relative to all naturally occurring even radioactive Elements. (See FIG. 13.)

So, a solidifying profile of the target radioactive Elements atoms creates a ready explanation why their decay rates are low, and half-life large. The natural solidifying profile leads to different nucleomagnetics orientation from atom to atom, and better alignment leads to the calculation of the decay rates and half-life specific to each Element. Finally, it is altering that natural rate that are the Claims of the present invention. It is the geometric calculation, like solidifying structure and shape, derived from my prior filing (Ser. No. 15/490,870), which defines a different science at the core of the present invention. The logic path, my AVSC atomic model science, is revolutionary and unique.

Through that alignment logic, the crystallization process does not need to be a material all the radioactive material. Another material in with 90 or 180 degrees preference in crystal may work; any semi-cubic crystal includes 90 degrees in combination which then aligns materials. Since commercial grade radioactive fuel can get achieved at 5%, then aligning the material does not need complete alignment to increase productive output. The doping process of silicon wafers with Boron or Phosphorus is one example of a doping the active agent into a crystal of another Element. The structure of silicon crystal is cubic-tetrahedron (half-cube). That makes the angle every other round of 90 degrees which produces alignment 180 degrees. The challenge is that the bonding angles of the Subshell-7t are not in alignment, but the same. Uranium may not line up with the silicon, but may line up with each other, which is the critical factor so ejections, at 90 degrees, arrive at 90 degrees, the channel for substantially better injections from one atom in the structure into another.

Present Invention Background

All the embodiments of the present invention are systems and methods to introduce, or return, nucleus particles past the electron field at an increased delivery rate to speed the nuclear decay by focusing them upon these entrance channels angles which are between electron settling positions. It overcomes my nucleomagnetics repulsion of the surrounding electrons by approaching where the electrons are not settled. Those are angles, or directions of attack, occur relative to the nucleomagnetics axis where the electrons are substantially less dense, or even empty.

The teachings of the present invention is that if you can send particles into nuclear waste at the correct angle (say +/−90 degrees for 094-Pu-Plutonium in one embodiment of the present invention), which has a nucleus-delivery rate at least 1,000× greater than approach at an angle of say zero (-0-) degrees or seventy-one (71) degrees which will get repulsed or deflected by one of the six of seven layers of electron subshell sitting direction in the path to the nucleus. That focus method would increase the delivery rate by at least 90×, past at least six electron shell layers, as the prior 1/90 random delivery with 89as a much lower rate gets replaced with 1/1 degree of a present invention process. That 90× improvement is greater than the 30× required to make nuclear waste processing commercially viable (less than ten years).

Redelivery—Squaring the Results—Reflection Creates More Particles for Delivery

The ratio of particle delivery and radioactivity is very small. If a half-life is 10,000,000 years for dispose of 1/2 of the material. That mean in any middle year say 1/10,000,000 of the material gets a particle delivery and decay reaction.

However, more important in radioactivity, is that the volume of outputs becomes the source of further decay reactions. That is the nature of the mathematics of exponential decay over time. It takes years just to get half of the stuff to convert. It will take another 10,000,000 years for the half of the remaining, or 1/4 of the stuff. As less atoms decay, there are less particles creating new decay.

Experimental evidence already showed that reflection, by encasing the radioactive material instead of leaving in the open, increase the decay. That is, a few particles are reflected back, so that is more particles for injection.

It is the teaching of the present invention that as successful particle inject gets improved, then reflection, if done at the correct angle of the teaching of the present invention, will increase correspondingly.

In that manner, some of the later Claims that include reflection added, are a method to make the increase operate by squares. The increase in delivery times the increase in output particle re-delivered again. In that manner, combination envisioned here can achieve more than the 30× commercial viability level by a combination of increasing particle delivery by 6×, and then the resulting ejected particles redirecting back into the process to cause a further 6× in downstream, secondary decay reactions. In that way, a successful embodiment of the present invention would achieve 36× decay rate improvement, more than enough to achieve commercial viability.

Background Challenges

One of the challenges of the present invention is the orientation process before or during delivery. Molecules do not line up without external methods. If we send particles, but the target atoms are moving or rotating, the process is back to random, and will not improve delivery. Those target orientation methods are in various embodiments of the present invention. In a solid material, these large atoms have all orientations as they fit against in each other, in many direction. That means that one layer might lay at the needed magnetic orientation as any of the millions of other layers of the material. Without the thoughtful process of the present invention, the orientation of molecules is random. Further, in liquid and gaseous states, the atoms or molecules are rotating themselves such that the axis is constantly changing, further hampering orientation efforts.

So, the target atoms do not naturally align. To get extremely strong alignment, other patents in nuclear magnetic resonance (“NMR”) (U.S. Pat. No. 4,051,429 and others) have identified methods and system that combines a) low Kelvin, and b) very strong Telsa magnetic fields create an alignment of particles that specific atoms and configurations show measurable differences in frequency. That method creates nucleomagnetics field alignment such that the same element delivers the same electron energy outputs in only one dimension, and as such measurable or comparable, which relate to the same inclination angle and distance of electrons relative to the nucleus. In some cases, those orientation methods are added to the present invention to create that path for decay for a new combination system in various embodiments of the present invention. However, existing NMR equipment does not provide launching of radioactivity into stable nucleus results, and certain not the present invention Claim of orientation, specific angles, and launching together. While FIG. 9 depicts two elements of NMR, the cooling and the strong magnetic orientation, prior art focusing on measuring frequencies for determining which elements and in which combinations those elements exist. The present invention adds the additional features of applying particle direction, and specific use for radioactive stabilization. Further, NMR works for extremely small samples, it is not designed for the commercial volume, but the present invention is scalable in ways described in later Claims.

Second, the alignment of approaching particles is part of existing university equipment. A person experience in nuclear research at the university would know as common knowledge the functions using that equipment Claimed herein. We will discuss later why the approach with neutrons has better success rate than an approach with protons, we consider the functionality as existing prior art, and subject to whatever rights apply to that method. This patent will always use approach particle accelerators in combination with present invention methods for a more complex complete system. So, while a patent search of ABST//(neutron AND accelerat) returns no results, a search of ABST//(proton AND gun) returns a use (U.S. Pat. No. 5,020,411) not related to the present invention.

Therefore, the present invention in various forms and Claims contains a) methods of orienting the target, b) methods of orienting the approaching particles, as c) systems applying parts of both those methods. It is the combination of those variants that are the Claims herein.

Prior Art Reflection as a Method to Increase Particle Delivery and Increase Decay

The increase of decay by using reflected particles is covered in prior art. One existing prior-art method (Claus Rolfs, Ruhr University, DE) is to place the target radioactive material in a heavy metal, such as 082-Pb-Lead. In that manner, the scientists have created more electrons surrounding the target and thereby ejected particles increasingly reflect back from hitting that increased count of electrons, and some reflect and penetrate.

One documented method simply adds material by encasing the radioactive material. That method shows marginal increases in the decay rate versus radioactive material sitting in the open. This process is still random; it only increases the number of random interaction in a linear fashion. The experimental evidence is strong that the decay rate increase when target material gets encased in metal. Yet, the Claim 7 related to FIG. 5 is the combination of a more refined reflection or concentration method with a present invention magnetic orientation angle.

However, the experience of those prior art re-delivery even close to the 30× potential needed for a commercial disposal process. General reflection, without the orientation and approach angle of the present invention, is not sufficient for the commercial purposes.

### Specifications

The teachings of the present invention is that when, using the preferred embodiment, nuclear particles, including protons or neutrons, get sent (independent Claim 1, independent Claim 6, and all others), reflected (Claim 7, 8 and independent Claim 19, and Claim 20), or both in combination, into nuclear waste, other radioactive material, and/or other physical materials, at the correct angle (say for 92-U-Uranium +/−90 degrees relative to the target atom's nucleus, as vertex, and its nucleomagnetics axis, other leg), particle delivery and thereby decay rates increase dramatically. It includes both orientation methods, and delivery methods, and others, such as control systems.

The critical feature is getting particles past the electron field into the target nucleus. If a particle is sent close to an electron settling position, that particle does not penetrate, but is reflected or deflected. However, if a particle is sent in the channel between electron settling positions at sufficient speed, then the particle will penetrate the shell, and deliver it for reaction into the nucleus. The present invention Claims the system and the specific angles for improved delivery of particles given the target has its magnetic orientation stabilized. This is the basis of independent Claim 1, independent Claim 6, independent Claim 19 and all others.

Part 1—Orientation

One of the challenges of the present invention is the orientation process which is required to get delivery rates at that angle. Molecules do not line up without external methods. The delivery may not naturally align with the correct angle of the oriented target. Those methods are in various embodiments of the orientation method and the delivery method.

Further, atoms and molecules constantly change orientation a) by their inherent heat energy, b) when in liquid or gas state, or c) even in solids, by subatomic interaction of moving particles, including electricity, magnetic fields, or other interactions. A static molecule, the obviously preference, would require zero Kelvin, and that has not been commercially achieved.

Finally, particular to many embodiments of the present invention, molecules in solids have different orientation of magnetics. Atoms fit into each other as best they can, and thereby have differences, in 3D, so exponentially more complex. Given the nucleomagnetics axis on one atom, the axis of the next atom in any direction may be both at a different inclination/longitude and at a different latitude/azimuth.

However, the science behind the present invention, my prior AVSC filing (Ser. No. 15/490,870) Claims that the electrons in all atom themselves have settling positions that can be calculated. Those are generally stable, within the frame of reference of the atom's particles as a set, around a nucleomagnetics axis of the nucleus with electrons at various inclinations and distances, the electrons shells.

I Claim (Claim 1) a number of ways to get more atom orientation alignment and stability by a) less temperature (Claim 3), b) standard crystallization (Claim 15), c) crystallization in the present of magnetics (Claim 16), d) strong magnetic fields without crystallization (Claim 16), and even e) strong electrostatic fields create magnetic orientation (Claim 15), and f) a method of adding the target Element into a crystal structure of another element (Claim 18). The various embodiments includes delivery to targets that are Elements pure and aligning nucleomagnetics, Elements not aligning (Claim 15, and Claim 16), compounds (Claim 14) that are not pure. The preferred embodiment of the present invention will improve or regulate the radioactivity of any number of options, and by various specified combinations of methods.

Of course, equal or exceeding our human-induced methods of prior art or the present invention is natural nucleomagnetics orientation. Natural orientation works to change the decay rate in ways important to understand for the present invention. For example, by electrostatic fields, in electron subshells imbalance across hemisphere, called, in prior art, 1/2 spin, atoms with odd-counts of electrons (odd Atomic Number). The electron-nucleus electrostatic dipole creates atom alignment, and some of that alignment is nucleomagnetics. FIG. 20 depicts this powerful natural alignment process.

This natural alignment process for 087-Fr-Francium drives the half-live down to 1,302 seconds, compared to 092-U-Uranium's half-life of millions of years. The raw power of nature is awe inspiring. An extra electron with both nucleomagnetics and electrostatic forces working together as such small distances creates exponential changes in the decay rate. The present invention cannot achieve that amazing power of nature, but it should achieve commercial viable methods to orient enough material of an Element a) to improve nuclear material production life, b) to reduce substantially nuclear waste, and c) provide paths for other safe uses of these heavy Elements. This ties into Claim 9. Further, the preferred embodiment of Claim 12, which varies the magnetic inducement method or the angle element changes to change the radioactive decay rate over a production life. As the percentage of radioactive material decreases, the method the present invention can change setting (as in Claim 9), such that output levels remains strong. That makes fuel more useful, and waste less radioactive.

The orientation desired is magnetics, and magnetics are created from nature materials from iron to neodymium, as well as induced from the movement of electrons through a wire wrapped multiple times in the same way. Magnetic alignment also can also be a by-product of electrical charge fields. As the charge aligns, certain nucleomagnetics get a consistent inclination (which is a partial nucleomagnetics alignment). This is the basis of Claim 10 of the present invention.

However, that alignment is not certain. For 89-Ac-Actinium or 91-Pa-Protactinium, there is still electrostatic alignment, a dipole from the odd, lone electron in one hemisphere. However, the unbalanced electron, per the teachings in my prior filing AVSC method (Ser. No. 15/490,870), is not on the nucleomagnetics angle. However, that aligns at the same inclination, and as a result, there is some improvement in the nucleomagnetics alignment, but not nearly as complete as the double electrostatic-nucleomagnetics convergence of 87-Fr-Francium. As a result, these odd-Atomic Number elements have faster decay rates from partial inclination alignment, and thereby short half-lives. However, none come close to the 1,302 seconds half-life of the 87-Fr-Francium.

The most powerful human-made method of atom orientation today is the combination of low temperature and strong magnetics for material in liquid suspension so the target atoms can move and orient without restrictions their own bonding which is used in NMR analysis. However, fine grinding can also break bonds that interfere with alignment. Strong ph dissolving can also break layers of materials. Further, crystallization, when created under the correct magnetic environment, also creates a material of multiple layers that may have some nucleomagnetics alignment.

In the present invention, this orientation improvement is usually done by magnetics. However, there are enhancements of temperature or sequencing of ranges (Claim 6 of the present invention) as the operations occur a) at temperatures above zero Kelvin, and b) materials that are in solid and so layer will hold atoms within a restricted range of angles different for different layers of atoms. That means that not every atom aligns. However, we can get a greater range of them. Further, by combining the orientation with the delivery, we can impact a subset.

When applying the present invention induced magnetic field, it works against any solidifying position torque for nucleomagnetics alignment. It will likely not move all particles, yet it should move solid atoms with +/−5 degrees. If so, then particle delivery should increase tenfold (5+5). If the resulting increase in radioactivity decay are similarly re-directed, the results square, so 10×10=10×, which exceeds commercial viability.

Further, high temperature increases the movement of the particles, even in solids. That movement creates its own self-induced magnetic field, which further creates torque against the present invention alignment. In that manner, the reduction of the temperature for the environment (Claim 3) will decrease that force, the required torque, and widen the range of solidifying orientation within the success zone.

On the downside, as the layers move, an entering particle may get deflected, and take a non-preferred angle at any layer. The optimal level, from preliminary calculations, is that for layers less than 100-1,000, deflections will not occur at a significant reduction to impact the commercial value unless those layer are highly aligned in nucleomagnetics. At layers greater than 10,000 the random orientation and deflections make the target delivery angle inconsistent at deep penetration into the material.

As such, the present invention has embodiments with:
Magnetics for orientation
Temperature to maintain orientation
Sequencing of operating the orientation/delivery systems at different angles to the material at different times to gather diverse ranges of atoms in a partial orientation enough for success given solid are basically random. That is, if magnetics of a specified strength only moves solids 10 degrees, then re-operation at each 10 degrees inclination in sequence, and at longitude change sequences similarly.

Part 2—Delivery and Even Re-Delivery

Further, delivered or return particles do not naturally align, and streams of neutrons or protons are rare naturally. Known natural penetrating particles, like gamma rays, were discovered by a few dots on film exposed over a period. That rate is not enough for commercial application. Therefore, the present invention includes a method of injection of particle—of course, at the calculated nucleomagnetics angle (Claim 1). The methods of that process are mostly well established. Electrons guns, and particle accelerators have been in operation in university for over 50 years. Re-direction and concentration is another. Specifically, we Claim the calculation of a preferred angle, within tolerance in Claim 1, and a specific angle in Claim 2, as support by FIG. 6 and FIG. 7. The delivery can be a groups of particles, as clarified in Claim 13.

The output of the present invention is to change the half-life of target materials as shown in FIG. 7. The half-live of Plutonium which is 2.8E+11 seconds, or over 10,000,000 years, could become less than ten (10) years. However, any significant reduction of the half-life or increase in the decay would have commercial value, or if the present invention gets used in combination with other methods to achieve the reduction goal. The value may from extending the useful life of existing nuclear plant fuel rods, and by less radioactivity of spent fuel because of that excess depletion.

If the approach path of a neutron or proton or combination thereof is near an electron, at some point the approaching particle gets closer to the electron than the target nucleus, and the nucleomagnetics repulsion become 1/distance-cube of a tiny distance, and thereby extremely large; larger than electrostatic 1/distance-square. At the Bohr radius, these are generally equal and counterbalancing (ignoring, for simplification here, the inclination strength factor of my prior filing (Ser. No. 15/490,870)), so at 1/4 the Bohr radius from the electron, the distance to the nucleus is probably 1-1/4 the Bohr radius. As a result, the nucleomagnetics force is 1/4-cubed which is 64× and the nucleus attraction is 1/(5/4)-cubed which is 0.51. So, the electron protection is 128× more repulsive in any arc of an electrons shell 1/4 the Bohr distance, and the neutron or proton does not penetrate. See my prior filing (Ser. No. 15/490,870) for more on how at subatomic distances nucleomagnetics is a) stronger and b) repulsive.

At 1/2, that ratio is the nucleomagnetics force is 1/2-cubed which is 8× and the nucleus attraction is 1/(1+1/2)-cubed which is 0.30×. So, the electron protection is 27× more repulsive in any arc of an electrons shell 1/2 the Bohr distance, and the neutron or proton does not penetrate. That 27× is about the 30× required for commercial viability.

Further, if you have five or six layers of subshells, the overlap radius of 1/2 for blockage, 97% of the surface will likely poor results, a reduction at 1/27× or worse because electron nucleomagnetics repulsion. As a result, the focus on the better 1-3% channels will have 128×, and thereby better decay rates. That 128× definitely exceeds the 30× commercial use requirement.

FIG. 1 depicts the teaching of the present invention showing two options. First, at great distance, the attraction (30103) may be bigger given that 1/distance-cube of nucleomagnetics shrinks more than a charge attraction at 1/distance-squared. However, at close range, the nucleomagnetics repulsion (30115) is greater, as shown that the net arrow changes direction (30102 versus 30111).

The mathematics of this is shown in prior art FIG. 204 for the Hydrogen atom, electron lml, settling position. Inside the Bohr radius, nucleomagnetics repulsion overpowers; outside the Bohr radius, electrostatic charge attraction overpowers. That leaves a settling position at the Bohr radius, where the two forces balance, and the particle tends to settle. Such is the case for the Hydrogen electron in a Hydrogen atom.

At a result, any slow-moving proton will stay outside the electron shell as a positive ionization at a further separation of the about the Bohr radius. Any neutron, with only nucleomagnetics force will get repelled to beyond that Bohr radius distance. Neutrons will not settle near the electron in the shell.

Therefore, the further analysis assumes the approaching particle has speed towards the atom and nucleus. FIG. 2 depicts the repulsion/defection logic as applied to particular atoms. It shows that an approach direction (30202) directly toward an electron deflects the approaching particle so it never penetrates to the nucleus. Another approach only near an electron will also get deflected (30220). Yet, an approach balanced between two electrons settling positions gets balancing forces (30207, 30212) such that the particle reaches the nucleus.

The calculation method of those forces is covered in my prior filing (Ser. No. 15/490,870). Those apply here to calculate properly the angle of attack and the speed of delivery. As shown in FIG. 192 of that filing (Ser. No. 15/490,870), repeated here a FIG. 6, at in inclination of 90 degrees for 092-U-Uranium, there are no electrons in any of the electron-shell layers from one to six, and the path has electrons at equal angles and distances at each side. It is a path with electrons balanced on each side. It is the calculation of the net-force of each element as they build upon each other for each element. The present invention is a specific, further application of the methods and Claims of that filing (Ser. No. 15/490,870).

It is further shown in FIG. 8, that for 97-Am-Americium, there are electrons in the equatorial subshell-7e, and thereby +/−90 degrees is not a preferred angle for delivery.

Therefore, in a narrow range where the approach path has balanced forces between two or move electron settling positions provides a likely path for particle injection into the nucleus. In the case of 92-U-Uranium, the path between 77 degrees in one hemisphere for one sub-shell set of electron and 77 degrees in the other hemisphere becomes 90 degrees, the equator.

It also helps that the equator is the largest area for approach. Other inclinations have a smaller area by the max of the sin-squared of the inclination angle starting at zero degrees at the nucleomagnetics axis.

It further helps that the equator has a delivery area that operates for the full circumference. If the atom rotates on the magnetic axis, the particle application works. Unlike other openings, if the atom, nucleus and electrons as a set, continues to rotate on the nucleomagnetics axis (part of any situation above zero Kelvin), that rotation still provides a clean, balance challenge for particle delivery for every latitude.

Material Preparations

The present invention includes Claims of operating the system in conjunction with another production use of the radioactive materials. This option is specified as dependent Claim 11. The use does not need to be post- or pre-production.

However, there are additional options that might occur pre-production use to either increase the productive life or make the de-activation process work better. For example, by preparing the material, in the presence of a magnetic field or an electrostatic field to induce a magnetic alignment such as:
Melting and solidifying
Dissolving in solvent and drying
Dissolving and crystallizing

All three of these are ‘breaking bonds’, then ‘causing reconnection of atomic bonds’ as described in Claim 4.

In the liquid state, atoms and molecules move freely, so the ratio of nucleomagnetics alignment will be poor. However, if the process includes a strong magnet in the back end, the ratio of alignment, and thereby success of the other elements of the present invention improves.

Comparison of Delivery Success Ratio for Protons versus Neutrons

In the calculation of tolerance ranges, there are two important factors. First, given radioactive materials all have at least six shells. In that way, a deflection from Shell-7 can get magnified such that the particle path and angle moves more in Shell-6, then Shell-5, and so on until the particle does not penetrate. This deflection is follows the momentum physics calculation, so increased speeds will increase the penetration depth of target corridor and widen it. The change must act upon the momentum, the mass times the velocity. So, with more velocity, the deflection will decrease.

In this manner a range that would fail at 1/3 Bohr radius, can get extended to over +/−1/2 Bohr radius over six layers, by an increase in speed of (3/2)̂(6) or about 11 times. A person knowledgeable in physics can create the entire table of speeds required for each Element based upon the number of layers as required. For practical purpose, the embodiments of the present invention, will increase particle speed until delivery ratios do not increase in a cost effective manner.

Now, let us review the dynamics of the closest shell, the Subshell-s, or 1m1, and 1m2 in AVSC nomenclature. The distance is very small. In the case of radioactive materials, evidence says that the 1s2 electrons are at the same distance as the radius of the nucleus itself. In AVSC, that is because the 1m2 electrons sit in the multi-layer cylinder structure of the nucleus.

FIG. 12 shows that electrons even at wider than the distance of that electron still get attracted into the nucleus because the huge different in the number of particles. At 235-count of the nucleus versus 1 electrons overwhelms the repulsion. That means that only an approaching electron (31211) that gets to the magnetic axis would get deflected.

At a distance of E-13, the nucleomagnetics of 235 Uranium particles (protons plus neutrons) at 1/1,000 the distance of the Bohr radius balancing point, creates 1,000 times the attraction. 235×1,000=235,000. The 92 protons repulsion is just that: 92×1=92. And the 1×1 electron is entirely immaterial. Almost anything, unless at extreme speed, like the speed of light, getting inside the electrons shells, and inside the Bohr radius, will get overwhelmed with nucleus attractions.

The only divergence is if that particle is a proton, and then hits a proton, without the neutron between. In that case, the distance can be near zero, which makes the proton repulsion going to infinite. That is the case, when these deliveries are when nuclear decay occurs.

However, in other cases, a neutron can get delivered and will get absorbed. That would be found as initially non-reactive. However, if that nudges the nearby nucleus structure to push a neutron out from between existing target protons, which is likely with a high impact neutron approach pushed lots of existing particles into different spaces, then those protons will repel near infinite force, and decay the 092-Uranium to a lower Element, say 088-Radium.

Therefore, while most people think that proton delivery is the better option, generating very high likelihood of nuclear decay, there is another factor. At the approach points, that proton-proton electrostatic repulsion is material. For approaching neutrons, we only have the nucleomagnetics attraction. Neutrons delivery much easier, and substantially more often than protons.

FIG. 13 shows the calculations that an approaching neutron is attractive to the nucleus throughout its path. This move it closer and closer to the perfect, say 90 degrees angle. The calculation of the force is physics negative-attractive. However, outside the Bohr radius, an approaching proton is net-repulsive to a nucleus. The challenge for protons is both deflection until it reaches that point where nucleomagnetics takes over as net-attractive. That repulsion will continue to change the angle, and potentially, make the approach deflect at any one of the six plus layers of electrons shells.

FIG. 8 depicts what happens in those alternatives. In the case of Proton, FIG. 8A, the repulsive electrostatic force (30803) is significant. In the case of neutrons, FIG. 8B, the repulsive electrostatic force (30813) is non-existent, creating only the nucleomagnetics attraction. In this way, a wide range of speeds and a wide channel around the target angle works for neutrons better than for electrons.

This prediction of the AVSC mathematics matches experimental evidence that neutrons delivery to the nucleus substantially better than protons.

Pre-Production, In-Production, Post Production

Various embodiments of the present invention would apply these systems and methods at every stage of use.

In pre-production, nucleomagnetics alignment will like increase its output in the actual production. Further, better aligned can apply the present invention.

In production, the systems and methods in various embodiments, may increase the output, as in decay rate. This can extend the life of these heavy elements. This has a further benefit that the final material once not usable, should be in a further decay state making the radioactivity less, and decreasing the required processing of for stability.

In post-production, unused materials needs steps to move from the radioactive state, now at lower, but still dangerous radioactivity levels, to levels with mostly stable Elements, and immaterial radioactivity.

Reflection and Concentration

The ability to use existing or created radioactive ejection particles better is covered in Claim 7 and Claim 8. As much as we Claim a method to direct particles, there is both existing particles that cause decay, and the additional particles from the Claim 1 target delivery.

First, some of these hit other particle inside the multi-atom material, and may cause. That is the natural decay rate. However, it occurs based upon the direction of ejection versus the high-success target angle.

Second, we can potentially focus those to other target materials, again at the preferred angle. In this way, by reflection or concentration, we can get the material outputs to create another round of decay increases.

Because particles are reflected by electrons, the ionization of the medium used should increase, as in Claim 8, reflection or concentration of ejected particles.

However, particles at the target angle delivery more reactions. In that way, the ability to reflect and/or concentrate in Claim 7, and reflect and/or concentrate using both materials. Now, the actual reflection and concentration may have multiple element, the FIG. 5 and FIG. 15 are meant as the basics. In practice, the elements might reflect in one step, and concentrate in one or more further steps. The basic method needs to take ejections from multiple particles in multiple direction, and first send them back towards the radioactive target, but also it must send them along a particle angle to the oriented atoms of the target. In my experience in satellite communications, we would have parabolic arrays, as well as secondary concentrators into a feed horn. A person knowledgeable in reflections and concentration could devise any number of arrangements that accomplish the three goals: reflections, concentration, and angle delivery.

Relationship of Decay Creates Opportunity for Present Invention to Replace Centrifuge Current Procedure

FIG. 21 calculates and displays as a graph with its R-square correlation percentage, the decay rates of natural radioactive element for the AVSC atomic model that the decay is based, exponentially, upon the ratio of the neutrons to the protons in the outer shell, and thereby more neutrons leads to a more stable atom, and a lower decay rate. At the left bottom, it the AVSC atomic model calculation of the nucleomagnetics nucleus structure up to 3-layers. The basic feature that every proton must have a neutron separating it from any neighboring protons, in any 3D direction. As a result, as shown the bottom left, the 3D structure is 6×6×6 which is 216 particles, most likely as a cylinder with one row, the core empty, as the chance to get an isolated proton at the center is highly unlikely. The determination of 210 shows at the bottom left. In 3D, that removes six particles from the 3D structure, so the number of nucleus particles in 3D stable is 216 less 6=210. The rest of the table reviews the elements for the number of protons and the number of neutrons around that 210 full 3D.

The main table compares radioactive Elements, and target Uranium isotopes, for number of protons, the Atomic Number, total nucleus particles, the Atomic Weight, and thereby calculates the number of neutrons by subtraction. It adds the change between Elements for each other those, protons, total nucleus particles, and neutrons. The table further adds the natural decay rate of each Element or, and a ratio comparison of neutrons versus protons. The results of that table compares the Subshell-7t Elements in an x,y graph of excess ratio versus the decay rate to show and calculate the correlation. The view indicates an exponential relationship, and the calculation shows a 96% R-squared correlation predictive rate.

It is important teaching of the present invention to understand that significant threshold at 210 nucleus particles. The next Element above 85-At-Astatine, the 210 Atomic Weight elements, jumps by ten (10) neutrons, but the four below has zero change in the neutron count. Remember the normal pattern is every two protons (avoiding the unbalanced-electron 1/2 spin odd Atomic Number Elements) gets either 2 if the structure is relatively open or 3 if the nucleus substructure is full. This pattern works from 86-Rn>88-Ra adds two (2) neutrons. This pattern works from 88-Ra>90-Th adds two (2) neutrons. This pattern works from 90-Th>92-U adds four (4) neutrons. That is ten (10) neutrons added for four (4) protons, the same 2.5 ratio as throughout the periodic chart.

The threshold is very obvious. The Atomic Weight changes almost zero change in neutron count over four elements—82-Pb (125.2), 83-Bi (126.0), 84-Po (125.0), and 85-At (125.0) as shown in FIG. 21. The first Element after that, when the structure must expand adds ten (10) neutrons to maintain stability. It jumps up nothing leading up to 210 particles, and then jumps a large ten (10) jump directly thereafter (210) relative to a significant nucleus structure change, the natural 210 (6×6×6 without centerline 6) become a threshold where extra neutrons fill it in 82-Pb-Lead, and an extra proton can replace that positions, but resist jumping above the 210 stable structure. This makes four Elements in a row with about 125 or 126 neutrons. Something special is happening at a subatomic level.

In the AVSC model, the alignments include two Elements from one and two electrons on the nucleomagnetics axis, 7 m. Those apply to 87-Fr-Francium and 88-Ra-Radium. 87-Fr-Francium atoms are special because the protrusion helps align on the nucleomagnetics. In the AVSC model, the alignments move from to ‘partial’ filling of three endcap electron settling positions, in Subshell-7t. That makes the Elements in that range comparable, as all have no nucleomagnetics alignment and endcap of protrusions. The endcap protrusions tilt molecules as they solidify. This makes decay rates naturally lower.

It is the teaching of the present invention that strong alignment at 90 degrees from the nucleomagnetics axis creates substantially higher decay rates. However, that does not apply to any Elements in this range, Subshell-7m (7s) and Subshell-7t (7d). That means, a secondary factor drives decay rates within this range. It is the teaching of the present invention that the secondary factor, after nucleomagnetics angle alignment, in decay rates is the arrangement of protons versus surrounding neutrons in the outer nucleus layer. In case of Subshell-7t, a low ratio makes decay faster exponentially. It is easier for an injection particle a) to get to protons upon delivery which is then ejected or b) displace neutrons such that existing protons get too close to each and electrostatic proton-proton repulsion overwhelms the situation so that creates ejection particles. Either path needs to radioactivity. FIG. 21 shows the evidence of that relationship. Radioactivity does not change in linear fashion from Element Atomic Number. 90-Th has excess ratio 2.67, 91-Pa 2.01, and the natural average of 92-Uranium are 2.50 and isotope-235 is 2.13, and isotope-237 is 2.38. Yet, when graphed, in the bottom right corner of FIG. 21, based upon the excess ratio, as defined by the AVSC nucleus model, the excess has excellent correlation to the decay rate. Low excess ratio equals high decay rate. In fact, the correlation is 96%, which is a very high confidence level; the AVSC excess ratio relates, even drives, decay rates.

This is natural science better defined by my AVSC atomic model; however, it has significant impact on the target of the present invention, radioactive materials. The current, prior art methods for using nucleomagnetics 92-U-Uranium, includes the separation via centrifuge to get the ratio of U-235 up to 5%, which is above the normal level. You can also note that the change of delivery rate of 6× creates a commercially viable fuel. This reinforces the 6×-square discussed earlier makes.

That means when the present invention increases decay rates for not just U-235, but also for U-237, it could achieve commercial viability of U-237, without the costly, difficult centrifuge process. By small changes bringing +3/−3 degree range of angles into AVSC alignment, the natural 1 degree preference, we can get the 6× improvement directly. U-235 would become 30× better, and U-237 would become 30× better making it as commercial usable as unmanaged U-235. Instead of centrifuges, the question is then the strength of magnetic fields, and temperature, and related magnetic torques in solid 92-U-Uranium. The Claims of the present invention provide method to achieve not just increased decay, but also eliminate difficult, costly existing requirements.

Mapping of the Claims—Dependency Trees, Source Paragraphs, and Figures

The Claims of the present invention include three (3) independent Claims, and 17 additional, dependent Claims for a total of 20 Claims.
Claim 1 is an independent Claim. It leads to dependent Claims 2-3, Claim 5, Claim 7, Claims 9-11, and Claims 12-17. Claim 3 has its own dependent in Claim 4. Claim 7 has its own dependent Claim 8. Claim 11 has its own dependents in Claim 12.
Claim 6 is an independent Claim.
Claim 19 is an independent Claim. Claim 19 has its own dependent in Claim 20.

Shown by groupings:
Claim 1
   Claim 2
   Claim 3
      Claim 4
   Claim 5
   Claim 7
      Claim 8
   Claim 9
   Claim 10
   Claim 11
      Claim 12
   Claim 13
   Claim 14
   Claim 15
   Claim 16
   Claim 17
Claim 6
Claim 19
   Claim 20

Specifications and Support Summaries for the Claims

Claim 1 includes the combination of magnetic alignment with the angle of attack of particle delivery. The FIG. 3 depicts that successful path, or angle of attached (30310) for a radioactive element, like 094-Pu-Plutonium, relative to its nucleomagnetics axis (30301). FIG. 4 depicts both the nucleomagnetics stabilization elements (30402, 30404) and the angle of approach (30407) delivery method (30405) as the basic combination for the preferred embodiment of Claim 1. Claim 1 is discussed in [0078], [0084], [0096], and [0133].

Claim 2 identifies that angle using my calculations of my prior filing (Ser. No. 15/490,870) for radioactive Elements; that an angle of 90 degrees relative to the nucleomagnetics axis would apply to certain radioactive elements, but not others. The ones identified at not useable contain equatorial subshells, putting blocking electrons in the 90 degree path. The issues are discuss at [0035] in background, and [0096] in the Specification.

Claim 3 includes the basic process, but adds the low temperatures, after a period in liquid state, such that atoms in solid form have more magnetic alignment. The cooling unit additions are shown in FIG. 9. The issues are discuss at [0084] in background, and [0092] in the Specification.

Claim 4 includes the basic process, but adds increasing nucleomagnetics orientation by solidifying the material in the presence of a strong magnetic field, such that atoms in solid form have more nucleomagnetics alignment. This is discussed at [0115] of the Specification.

Claim 5 includes the basic process, but adds increasing nucleomagnetics orientation by solidifying by crystallization the material in the presence of a strong magnetic field, such that atoms in solid form have more nucleomagnetics alignment. This is discussed at [0046] in the background and [0078] of the Specification.

Claim 6 includes the basic process, but allows the segmentation in time and angle because solids may have atom arrangement that cannot be completely aligned. However, in a strong magnet, direction can get worked for a range, making the challenge manageable and financially viable. The critical aspect of this Claim is that the use of Claim 1 works in tandem, the orientation with the particle approach at the chosen inclination angle. If the material has atoms of different orientations, then we can change both the magnetic feature and the particle delivery feature as a group to group atoms in groups of angles. This segment work and partial alignment is depicted in FIG. 17, FIG. 18, and FIG. 19. It is discussed at [0090] in the Specification.

Claim 7 is the standard process adding the re-delivery of particles as a method in increase that radioactivity creates its own cause. However, from random direction, the output would only get the natural decay rate. An increase by Claim 1 would only be linear. However, when ejected particles get reflected using the same angles determined, and re-delivered, the increases in radioactivity can increase by the square of the increase. That way an improvement of 10 becomes 10×10=100×. The system is depicted in FIG. 5, FIG. 15, and FIG. 16 and discussed at [0063-0068] in background, and at [0074-0077] and in [0132-137] in the Specifications.

Claim 8 is the basic system plus Claim 7, reflection, concentration, or re-delivery at the preferred angle of ejected particles where the reflection is enhanced by ionization. It is discussed in [0132-137] in the Specifications.

Claim 9 is the basic system with the addition of control system for the magnetic methods and particle delivery method that would be common for safety. FIG. 15 depicts this expanded system use contemporaneously with the present invention. It is discussed at [0053] in Background and at [0086] in the Specifications.

Claim 10 is the basic system with electrostatic fields as the method to induce nucleomagnetics. FIG. 18 depicts how an electrostatic field produced with positive and negative at the perpendicular aligns multiple atoms in nucleomagnetics axis as a result. It gets discussed in [0037] in Background, and in [0087] in the Specification.

Claim 11 is the basic system when integrated with another live production system, such as a nuclear power plant. FIG. 16 depicts the two operating simultaneously, and gets discussed at [0111] in the Specification.

Claim 12 is the basic system applied at a changing rate to fuel, such that the production can remain more steady as the fuel depletes in its decay exponential rate. It further can use depleted materials to still achieve production that both increase useful life, and reduces the radioactivity danger level of the waste product. It gets discussed at [0086].

Claim 13 is the basic system applied with particles as a group. Currently, direct addition of particles has been done to create the synthetic elements from 93Np-Neptunium to 118-Og-Organesson. Buy delivering cations of protons plus neutrons, and proton repulsion, the neutrons arrive first providing a better ratio of enrichment reactions versus decay reactions. It gets discussed in [0006] in the Background, and in [0096] in the Specification.

Claim 14 is the basic system applied to materials that may not be purely aligned or even pure itself. This may be more complex in both orientation, as their solidifying structures may create complex directions and torques for the nucleomagnetics axis, and particle delivery, as different Elements may be different target angles. However, it is clear than many combinations remain feasible, and the effort to only work with pure materials in unnecessary, allowing for a commercial savings. It is discussed in [0084]. It is important to note that, for energy production, the preferred embodiment of Claim 9, may eliminate the need for the whole centrifuge process because the U-237 can also reach productive decay rates.

Claim 15 is the basic system applied when material has some natural alignment in a crystallized structure. Note that often the nucleomagnetics angle of a crystal is not the bonding angle of the atoms. For example, silicones bonds at 90 degrees in a cubic-tetrahedron structure, but the nucleomagnetics axis is offset from the bonding angles by 53 degrees. A similar calculation is available for every element to get applied to the present invention. It is discussed in [0084].

Claim 16 is the basic system where the crystallization process is further enhanced with magnetics. While the crystals might form, the nucleomagnetics still might not align. For example, in cube-tetrahedron, the magnetics can build out of any corner of the cube. However, if build in a strong magnetic field, the growing crystal adds atoms that more often do have the same magnetic alignment. As such, the multi-particle result will exhibit much more magnetic alignment for the basic Claim 1 process. It is discussed in [0084].

Claim 17 is depicted in FIG. 18. It is found that electrostatic fields can produce alignment of the nucleomagnetics according the inclination angles determined by AVSC (my prior filing Ser. No. 15/490,870). Further, electrostatic force decreases at 1/distance-square versus magnetic decreases at 1/distance-cubed, so if possible, an electrostatic field is usually a more powerful creator of nucleomagnetics alignment, if the angle work out. It is discussed in [0059] in Background, and in [0084], [0089], and [0112] in the Specification.

Claim 18 is referenced at [0059] in the Background, and at [0084] in the Specification. It applies to the basic Claim 1 the stability of crystallization, especially with the cubic structure that adds 90 degree angles. The angles get some nucleomagnetics alignment, although that may still vary by latitude or different frames of the crystal.

Claim 19 depicts an embodiment of the present invention which was an additional Claim 7 can operate without new particle delivery method. This is a system where the source of particles is the output from existing radioactive decay of the target material. The concept is covered in FIG. 5, FIG. 15, and FIG. 16 and discussed at [0063-0068] in background, and at [0074-0077] and in [0132-137] in the Specifications.

Claim 20 depicts an embodiment of Claim 19 with the addition benefit of ionization of the reflection and/or concentration surfaces. This is the same relationship as Claim 8 to Claim 7. The concept is covered in FIG. 16 and discussed at [0063-0068] in background, and at [0074-0077] and in [0132-137] in the Specifications.

### DETAILED DECRIPTION OF THE DRAWINGS

FIG. 1 depicts alternatives on electrons relative to nucleus particles at either closer than the Bohr radius, or outside the Bohr radius direction for the net force of electrostatic charge attraction versus nucleomagnetics repulsion in other directions versus the preferred embodiment of the present invention for delivering a nuclear particle, proton or neutron, to a target nucleus such that the path is balance between the nearby electron settling positions. In these, an electron is shown as a black sphere, and a nucleus as a ring with white in its middle. Electrostatic force is shown by an arrow with pattern interior, nucleomagnetics force is shown by an arrow with white interior, and the net force of those two is shown by a hashed-outline arrow. FIG. 1A, for locations outside the Bohr radius, depicts the net force (30102), as vectors, balances of electrostatic attraction (30105) versus nucleomagnetics repulsion (30103) between a nucleus (30103) and an electron (30104). Visually, it shows that the combination of the net force (30106) and the nucleomagnetics repulsion (30106) equals the electrostatic attraction (30103) by showing them as the same length in combination. FIG. 1B, for locations inside the Bohr radius, both forces (30113, 30115) are larger than in FIG. 1A (30103,30105) as shorter distance and the 1/d-factor. Given 1/distance-squared versus 1-distance-cubed, the nucleomagnetics force (30115) grows faster, so, as vectors, such that nucleomagnetics repulsion (30113) outweighs electrostatic attraction (30115) creating a net repulsion (30111). Visually, it shows that the combination of the net force and the nucleomagnetics repulsion equals the electrostatic attraction (30103) by showing them as the same length in combination.

FIG. 2 depicts alternative directions versus the direction of the preferred embodiment of the present invention for delivering a nuclear particle, a proton or a neutron, to a target nucleus such that the particle or particles best pass the electrons in a shell/field around the target atom's nucleus. All directions utilize a target atom consisting of a nucleus (30204) and various electrons (30203, 30205) in settling positions around that nucleus. In an approach path (30202) for a particle (30201) in the general direction of an electron (30203), the particle gets repelled when closer than the Bohr radius by the net force as described in FIG. 1, and leaves (30206) without penetration to the nucleus. In a different approach path (30217) for an particle (30216) direction in somewhat near one (30203) to an electron, the particle gets first attracted inside the Bohr radius (30218), then repelled (30219) when closer than the Bohr radius, as described in FIG. 1, and leaves (30220) without penetration to the nucleus. In the preferred embodiment of the present invention, approach path (30209) for an particle (30210) in a direction balance between the forces of the two closest electrons (30203) the particle first attracted by both, then gets repelled, when closer than the Bohr radius, by both, such that the particle (30210) penetrates the 30212) to the nucleus and creates a further nucleus reactions, often decay (fission) as in one preferred embodiment of the present invention, although sometimes that particle addition creates fusion.

FIG. 3 depicts the Settling Locations of Electrons into Subshells and Open Path for Particle Approach. For an atom with a nucleomagnetics axis (30301) and a target nucleus (30306), the drawing depicts electrons in subshells starting as a subshell of one in each hemisphere (1×2), 6m2 (formerly called 6s2) (30302, 30308). The drawing depicts electrons in a subshell of three in each hemisphere (3×2), 6t6 (formerly called 6p6) (30303, 30307). The drawing depicts electrons in a subshell of five (5) in each hemisphere (3×2), 6u10 (formerly called 5d10) (30304). The drawing depicts electrons in a subshell of seven (7) in each hemisphere (7×2), 6t14 (formerly called 4f14) (30305). That leaves an open path (30309) for an approaching particle (30310) between two of the subshells (30306).

FIG. 4 depicts the preferred embodiment of the present invention for Claim 1 where atom or atoms get oriented by each's nucleomagnetics axis (30401) by a magnetic element (30402, 30404) and the particles (30406) are delivered along a path or direction (30405) at a particular angle (30407) for nucleus interaction at a higher rate than the than the natural state of random directions of approach.

FIG. 5 depicts the preferred embodiment of the present invention for Claim 9 a focusing element gets added to the FIG. 4 features for ejected particles to get reflected and refocused back at the target material at the calculated angle of the present invention. FIG. 5 depicts one embodiment of the present invention where atom or atoms get oriented by each atom's nucleomagnetics axis (30501) by a magnetic element (30502, 30504) and ejected particle or particles (30508) from the target molecules, which might be in a different angle from existing or trigger radioactive decay get reflected by an element (30507) such that the path or direction (30505) of the returning particle (30508) aligns with the preferred embodiment of the present invention for nucleus interaction at a higher rate than the than the natural state of random directions of approach, and reflected randomly.

Table 6 depicts the two outer electrons subshells configurations for the element 092-U-Uranium. This was FIG. 192 of my prior U.S. application Ser. No. 15/490,870. FIG. 6 depicts two views of an atom of the element 092-U Uranium and its electron shells in the preferred embodiment of my prior filing. Each view is relative to the magnetic axis of the atom. FIG. 6A is an equator view showing the two most outer shells, in this case Shell-6 and Shell-7. FIG. 6B is a polar view of just the most outer shell, Shell-7, and its subshells, in this case, Subshell-7m. FIG. 6C is an equator view of just the most outer shell and its subshells, in this case, Subshell-7m and Subshell-7t.

FIG. 6A shows the two outer shells, Shell-6 (19204) and Shell-7 (19206) of an atom of the element 092-U Uranium where there is a magnetic axis (19201) through the nucleus (19202), which defines a plane (19203) that separates the atom into two hemispheres (north and south). In Shell-6 (19204), which is full, there are eighteen (18) electrons as described in FIG. 136; six electrons not on the magnetic axis (19201) settle at a 36-degree angle (19206) to that magnetic axis (19201) with nucleus (19202) as the vertex, and ten electrons not on the magnetic axis (19201) settle at a 72-degree angle (19209) to that magnetic axis (19201) with nucleus (19202) as the vertex. In Shell-7 (19209), Subshell-7m includes two electrons, e-7m1 and e-7m2 (19221,19222), which settles on the magnetic axis (19201). Subshell-7t includes four electrons, e-7t1, e-7t2, e-7t4, and e-7t5, (19217,19221). There are no electrons in Subshell-7u or Subshell-7v.

FIG. 6B shows the outer shell, Shell-z7, of an atom of the element 092-U Uranium, viewed from one magnetic pole (19276) shown as a point, because this 2D view is perpendicular to the page. Shell-7 includes Subshell-7m (19277). Two electrons settle in Subshell-7m (19276), one electron, e-7m1 (19261) in front and one electron (19260) in the back hemisphere. Subshell-7t includes four electrons, e-7t1, e-7t2, e-7t4, and e-7t5 (19268). There are no electrons in Subshell-7u or Subshell-7v.

FIG. 6C shows the equator view of electrons and bonding positions of only the outer shell, Shell-6, of 092-U Uranium shows a magnetic axis (19240) with a plane (19241) through the nucleus separating the atom into two hemispheres. Two electrons (19242, 19243), e-5m1 and e-5m2, settles in Subshell-7m at the polar ends of the structure. Subshell-7t includes four electrons, e-7t1, e-7t2, e-7t4, and e-7t5 (19242). There are no electrons in Subshell-7u or Subshell-7v.

For FIG. 7, the bottom shows the list of subshells with their settling angles between the electrons in that subshell relative to the magnetic axis angles with the nucleus as the vertex for the Element 109-Mt-Meitnerium. For the preferred embodiment of the present invention for Claim 2, choosing the angle 90 degrees which is between the 6v14 north electrons subshells at 77 degrees and the 6v14 south at 77 degrees. However, there are other angles between ones on the table, if inner layers are further taken into consideration. The reader should note that the 90 degree angle is just one embodiment of the present invention for certain Elements. A person knowledge in the mathematics can determine other directions for improved delivery of particles.

FIG. 7A shows the two outer shells, Shell-6 (30704) and Shell-7 (30706) of an atom of the element 109-Mt-Meitnerium where there is a magnetic axis (30701) through the nucleus (30702), which defines a plane (30703) that separates the atom into two hemispheres (north and south). In Shell-6 (30704), which is full, there are eighteen (18) electrons as described in FIG. 136; six electrons not on the magnetic axis (30701) settle at a 36-degree angle (30706) to that magnetic axis (30701) with nucleus (30702) as the vertex, and ten electrons not on the magnetic axis (30701) settle at a 72-degree angle (30709) to that magnetic axis (30701) with nucleus (30702) as the vertex. In Shell-7 (30709), Subshell-7m includes two electrons, e-7m1 and e-7m2 (30721, 30722), which settles on the magnetic axis (30701). Subshell-7t includes four electrons, e-7t1, e-7t2, e-7t4, and e-7t5, (30717, 30721). There are no electrons in Subshell-7u or Subshell-7v.

FIG. 7B shows the outer shell, Shell-7, of an atom of the element 109-Mt-Meitnerium, viewed from one magnetic pole (30776) shown as a point, because this 2D view is perpendicular to the page. Shell-7 includes Subshell-7m (30777). Two electrons settle in Subshell-7m (30776), one electron, e-7m1 (30761) in front and one electron (30760) in the back hemisphere. Subshell-7t includes four electrons, e-7t1, e-7t2, e-7t4, and e-7t5 (30768). There are no electrons in Subshell-7u or Subshell-7v.

It is important to note for FIG. 7 that electrons of this element, 109-Mt-Meitnerium, sit in the 90-degree subshells (30921), unlike most other elements. As such, the Claim 2 preference for 90 degrees does not apply to elements of this group as stated.

FIG. 8 depicts that alternatives of using a proton versus using a neutron creates a net repulsions and difficulty of delivery into the nucleus for a proton versus a very strong attraction and very high delivery rate into the nucleus for a neutron. FIG. 8A depicts where it is a proton particle (30801) approaching a nucleus (30804). In that situation, the combination of particles creates a magnetic attraction (30805) and an electrostatic charge repulsion (30803) which creates a net repulsion (30807) which tends to deflect the path (30802) of the approaching proton particle (30801). FIG. 8B depicts where it is a neutron particle (30811) approaching a nucleus (30814). In that situation, the combination of particles creates a magnetic attraction (30815), yet no electrostatic charge repulsion (30813) which creates a relative full repulsion (30816) which tends to further attract the path (30812) of the approaching proton particle (30811). Similar to the event horizon of a black hole, for the neutron that is a horizon around a nucleus where capture an almost certainty. Yet, for protons that capture is limited as high speeds and the extra proton-proton repulsion may make capture limited.

FIG. 9 depicts the preferred embodiment of the present invention for Claim 7 with both magnetic and cooling elements stabilize atoms, and methods delivery particles at a particular angle relative to the target nucleomagnetics axis. It depicts where atom or atoms get oriented by each's nucleomagnetics axis (30901) by a magnetic element (30902, 30904), and further stabilized in that orientation by cooling elements (30908, 30909), and the particles (30906) are delivered along a path or direction (30905) at a particular angle (30907) for target nucleus interaction at a higher rate than the than the natural state of random directions of approach.

FIG. 10 depicts a 2D representation of the electron subshell placement relative to the nucleus and its nucleomagnetics axis for an atom of 088-Ra-Radium. It has a nucleus (31005) and its nucleomagnetics axis (31005). It has electrons on both hemispheres in groups at the same distance from the nucleus and inclination relative to the nucleomagnetics axis with the nucleus as the vertex, including:
Subshell 1m (31008)
Subshell 2m, 2c (31009)
Subshell 3m, 3f (31006)
Subshell 4m, 2c (31007)
Subshell 5m, 2c (31004)
Subshell 6m, 2c (31001)
Subshell 7m (31002)

FIG. 11 depicts the paths of approaching particles relative to the electrons in subshell 1m, which is closest to the nucleus. The presentation consists of a nucleus (31104) and its nucleomagnetics axis (31101). There are two electrons in subshell-1m: 1ml (31105) and 1m2 (31103) on either hemisphere created by the equator plane (31104) of the nucleus (31102). Approaching particle (31112), at the correct angle (31110), even to the left, in this drawing, of electron 1m2 (31103) get pulled towards the nucleus and get captured because the count of particles (protons and neutrons with magnetics) is high, and nucleomagnetics is stronger at subatomic distances. An approaching particle (31111) at the correct angle (31108) must be far to the right before proton-electron electron 1m2 (31103) nucleomagnetics repulsion to deflect the particles, and avoid capture.

FIG. 12 documents the calculation of net-force for electrostatic and nucleomagnetics comparing an approaching neutron with an approaching proton. In the case of a neutron, there is not electrostatic force, so the only force is naked nucleomagnetics which is an attraction (negative force in physics). In the case of a proton, the nucleomagnetics is offset by electrostatic charge repulsion such that the net for is physics positive, and thereby repulsive at the chose distance.

FIG. 13 shows a table of the natural half-life of radioactive elements, and their half-lives if just the particle delivery rate increase 30× by the 90:1 limitation of angle of the present invention.

FIG. 14 shows a table of the natural half-life of radioactive elements, and their half-lives if both the particle delivery rate increase 30× by the 90:1 limitation of angle of the present invention, and that creates additional particles which can also get directed at the angle of the preferred embodiment of the present invention. In that case, the 30× increase in particles started will get 30-squared or 9,000 faster decay, and the new half-lives as documented by periodic chart element.

FIG. 15 depicts the preferred embodiment of the present invention for Claim 7 which features adding a control system to the elements of FIG. 5. FIG. 5 depicts one embodiment of the present invention where atom or atoms get oriented by each atom's nucleomagnetics axis (31501) by a magnetic element (31502, 31504) and ejected particle or particles (31508) from the target molecules, which might be in a different angle from existing or trigger radioactive decay get reflected by a method (31507). In addition, in this embodiment of the present invention for Claim 7, the system has a monitoring device (31511) which take inputs, including but not limited to the radiation achieved, and has feeds back to change or stop (31512) the magnetics method (31502, 31504) or the particle delivery method (31510).

FIG. 16 depicts one embodiment of the present invention for Claim 7 which includes particle alignment, particle delivery, or re-delivery at a particular angle, and a live production system. For an atom of radioactive material in a multi-atom solid, there is a nucleus (31603) and its nucleomagnetics axis (31601) where the nucleomagnetics axis of multiple atoms get aligned by a method (31602, 31604). At a calculated angle (31609), there is a delivery mechanism (31610) for particles (31608) to the nucleus (31603), and/or a reflection method (31607) to take ejected particle of prior radioactive decay (31606) and redirect those into that flow (31605) and the calculated angle (31609). That system is attached is a live production system (31611) which might be a heat exchanger for energy production.

FIG. 17 depicts alternatives between the natural state of atoms, and their nucleomagnetics axis in natural state versus when a magnetic method is applied. FIG. 17A shows that, in a solid, there are multiple atoms (31701, 31702, 31703, 31704, 31705, 31706). However, one atom (31702) marked with a star (31707) would have an alignment and none of the others would. FIG. 17A shows the preferred embodiment of the present inventions such that, in a solid, there are multiple atoms (31701, 31702, 31703, 31704, 31705, 31706). Yet because of the magnetic alignment method (31718), groups of atom (317002, 31714, 31715) marked with starts (31717) with similar, but not sufficient alignment, would have a sufficient alignment by the added method for processing as a group.

FIG. 18 depicts that nucleomagnetics alignment can occur by either applied magnetics or an applied electrostatic charge field. In FIG. 18A, repeats FIG. 17B, where a number of atoms (31802, 31804, 31805) get aligned by a nucleomagnetics method (31807) out of the full group of atoms (31801-31806) in a solid material. FIG. 18B shows the same results, where the nucleomagnetics method is an anode (31817), and cathode (31818) electrostatic field driving a consistent nucleomagnetics field of the atoms.

FIG. 19 depicts that nucleomagnetics alignment can occur naturally for one-hemisphere-electron imbalance, also called 1/2 spin. In nature, as depicted in FIG. 19A, if the material has even-count Atomic Number, then all electrons have a balancing atom in the opposite hemisphere at the same inclination. As a result, not electron dipole occurs, and the nucleomagnetics axis do not align. This is shown as only one atom (31902) having a horizontal nucleomagnetics axis alignment which the rest do not. In that case, the decay rates is slower due to non-alignment. However, as depicted in FIG. 19B, in the case of odd-count Atomic Number, one hemisphere has an extra electron. Thereby, each atom has an electrostatic dipole, and thereby tend to align by electrostatic charge. The negative on one atom finds the positive end of another atom, which happens to increase nucleomagnetics alignment as well as shown by more atoms aligned (31912, 31914, 31915) versus not.

FIG. 20 depicts the natural alignment of the nucleomagnetics axis, which leads to increased decay rate, for 87-Fr-Francium. It consists of two section; the first showing one atom alone and its solidifying structure, and the second showing that structure favors a strict alignment of the nucleomagnetics axis of that Element's atoms.

FIG. 20A shows the outer subshells from an equator view. The atoms has a nucleomagnetics axis (32001). In Shell-7, there is only one electron, 7m1, (32002) which sits on the nucleomagnetics axis (32001). In Shell-6, also on the nucleomagnetics axis (32001), sits Subshell-6m, 6m1 (32003) and 6m2 (32009). Next, moving from axis to equator is the Subshell-6t (32004, 32008), then Subshell-6u (32005, 32007), and then Subshell-6v (32006). For the 2D, we have not shown that those outer shells have multiple electrons in them. The value of this drawing is that the 87-Fr-Francium Element atoms all have one electron, 7m1 (32002), sticking out directly on the nucleomagnetics axis (32001) as a structure (32010, and the opposite pole has its 6m2 electron (32009) at in indented positions (32012) because of the lower nucleomagnetics repulsion force between the nucleus and electrons along the axis versus other inclinations. This creates an electrostatic differential from the lone 7m1 electrons (32002) as a negative charge (−) (32011) towards the nucleus (32013) as a positive charge (+) (32014). Therefore, the atom expresses an electromagnetic dipole axis that is the same as the nucleomagnetics axis (32001).

FIG. 20B depicts how multiple atoms of Element 87-Fr-Francium solidify with both nucleomagnetics axis and electrostatic dipole fully aligned. In a series of three depicted atoms (32012, 32015, 32016), the 6m2-electron indent (32013) of one atom (32012) attracts the 6m1-electron protrusion (32014) of the next atom (32015). On exactly the same axis, the electrostatic dipole from negative (32018) to positive (32019) of one atom (32012) attracts the electrostatic negative end (32020) of the next atom (32015). As a result, the forces are very strong to keep the atoms in a line for electrostatic force, and to keep the nucleomagnetics axis (32011) in line with the nucleomagnetics axis further (32017) in the atom solidifying structure.

FIG. 21 calculates and displays as a graph with its R-square correlation percentage, the decay rates of natural radioactive element for the AVSC atomic model that the decay is based, exponentially, upon the ratio of the neutrons to the protons in the outer shell, and thereby more neutrons leads to a more stable atom, and a lower decay rate. At the left bottom, it the AVSC atomic model calculation of the nucleomagnetics nucleus structure up to 3-layers. As a result, as shown the bottom left, the 3D structure is 6×6×6 which is 216 particles, most likely as a cylinder with one row, the core empty, as the chance to get an isolated proton at the center is highly unlikely. The main table compares radioactive Elements, and target Uranium isotopes, for number of protons, the Atomic Number, total nucleus particles, the Atomic Weight, and thereby calculates the number of neutrons by subtraction. It adds the change between Elements for each other those, protons, total nucleus particles, and neutrons. The table further adds the natural decay rate of each Element or, and a ratio comparison of neutrons versus protons. The results of that table compares the Subshell-7t Elements in an x,y graph of excess ratio versus the decay rate to show and calculate the correlation. The view indicates an exponential relationship, and the calculation shows a 96% R-squared correlation predictive rate.

### BRIEF DESCRIPTION OF THE DRAWINGS

FIG. 1 depicts alternatives on electrons relative to nucleus particles at either closer than the Bohr radius, or outside the Bohr radius direction for the net force of electrostatic charge attraction versus nucleomagnetics repulsion in other directions versus the preferred embodiment of the present invention for delivering a nuclear particle, proton or neutron, to a target nucleus such that the path is balance between the nearby electron settling positions.

FIG. 2 depicts alternative directions versus the direction of the preferred embodiment of the present invention for delivering a nuclear particle, proton, or neutron, to a target nucleus such that the particle or particles best pass the electrons in a shell/field around the target atom's nucleus.

FIG. 3 depicts the Settling Locations of Electrons into Subshells and Open Path for Particle Approach.

FIG. 4 depicts the preferred embodiment of the present invention for Claim 1 where atom or atoms get oriented by each's nucleomagnetics axis (30401) by a magnetic element (30402, 30404) and the particles (30406) are delivered along a path or direction (30405) at a particular angle (30407) for nucleus interaction at a higher rate than the than the natural state of random directions of approach.

FIG. 5 depicts the preferred embodiment of the present invention for Claim 9 a focusing element gets added to the FIG. 4 features for ejected particles to get reflected and refocused back at the target material at the calculated angle of the present invention.

Table 6 depicts the two outer electrons subshells configurations for the element 092-U-Uranium. This was FIG. 192 of my prior U.S. application Ser. No. 15/490,870.

For FIG. 7, the bottom shows the list of subshells with their settling angles between the electrons in that subshell relative to the magnetic axis angles with the nucleus as the vertex for the Element 109-Mt-Meitnerium.

FIG. 8 depicts that alternatives of using a proton versus using a neutron creates a net repulsions and difficulty of delivery into the nucleus for a proton versus a very strong attraction and very high delivery rate into the nucleus for a neutron.

FIG. 9 depicts the preferred embodiment of the present invention for Claim 7 with both magnetic and cooling elements stabilize atoms, and methods delivery particles at a particular angle relative to the target nucleomagnetics axis.

FIG. 10 depicts a 2D representation of the electron subshell placement relative to the nucleus and its nucleomagnetics axis for an atom of 088-Ra-Radium.

FIG. 11 depicts the paths of approaching particles relative to the electrons in subshell lm, which is closest to the nucleus.

FIG. 12 documents the calculation of net-force for electrostatic and nucleomagnetics comparing an approaching neutron with an approaching proton.

FIG. 13 shows a table of the natural half-life of radioactive elements, and their half-lives if just the particle delivery rate increase 30× by the 90:1 limitation of angle of the present invention.

FIG. 14 shows a table of the natural half-life of radioactive elements, and their half-lives if both the particle delivery rate increase 30× by the 90:1 limitation of angle of the present invention, and that creates additional particles which can also get directed at the angle of the preferred embodiment of the present invention.

FIG. 15 depicts the preferred embodiment of the present invention for Claim 7 which features adding a control system to the elements of FIG. 5.

FIG. 16 depicts one embodiment of the present invention for Claim 7 which includes particle alignment, particle delivery, or re-delivery at a particular angle, and that system is integrated with a live production systems.

FIG. 17 depicts alternatives between the natural state of atoms, and their nucleomagnetics axis in natural state versus when a magnetic method is applied.

FIG. 18 depicts that nucleomagnetics alignment can occur by either applied magnetics or an applied electrostatic charge field.

FIG. 19 depicts that nucleomagnetics alignment can occur naturally for one-hemisphere-electron imbalance, also called 1/2 spin for Elements with or without 1/2 spin.

FIG. 20 depicts the natural alignment of the nucleomagnetics axis, which leads to increased decay rate, for 87-Fr-Francium. It consists of two sections; the first showing one atom alone and its solidifying structure, and the second showing that structure favors a strict alignment of the nucleomagnetics axis of that Element's atoms.

FIG. 21 calculates and displays as a graph with its R-square correlation percentage, the decay rates of natural radioactive element in comparison to the for the AVSC atomic model that the decay is based, exponentially, upon the ratio of the neutrons to the protons in the outer shell, and thereby more neutrons leads to a more stable atom, and a lower decay rate.

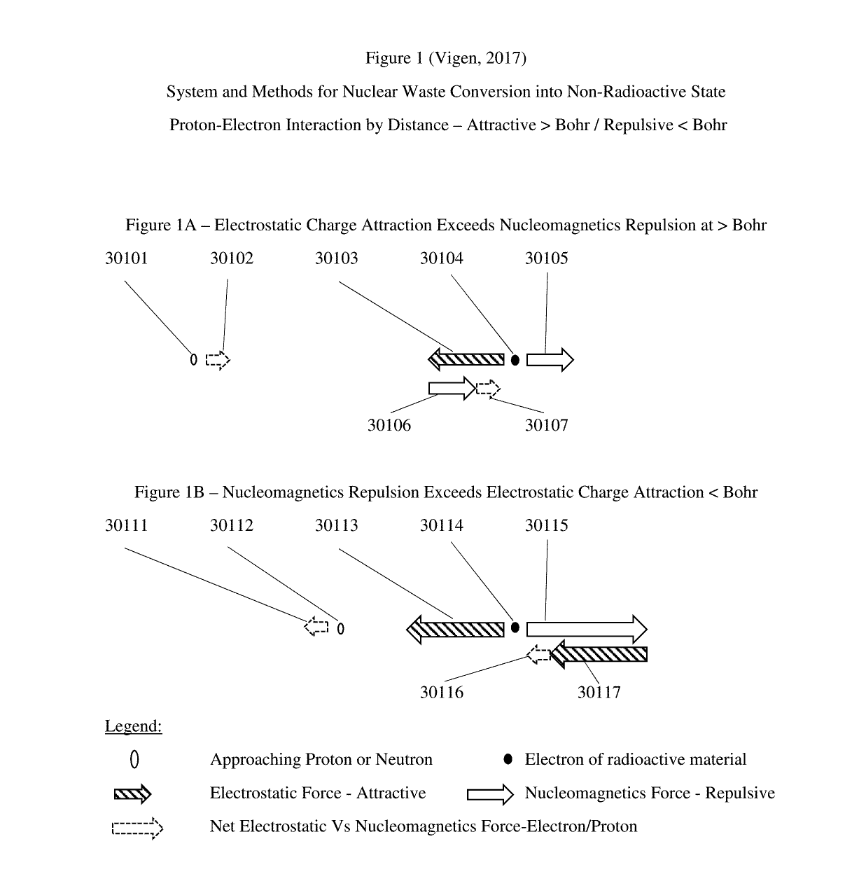

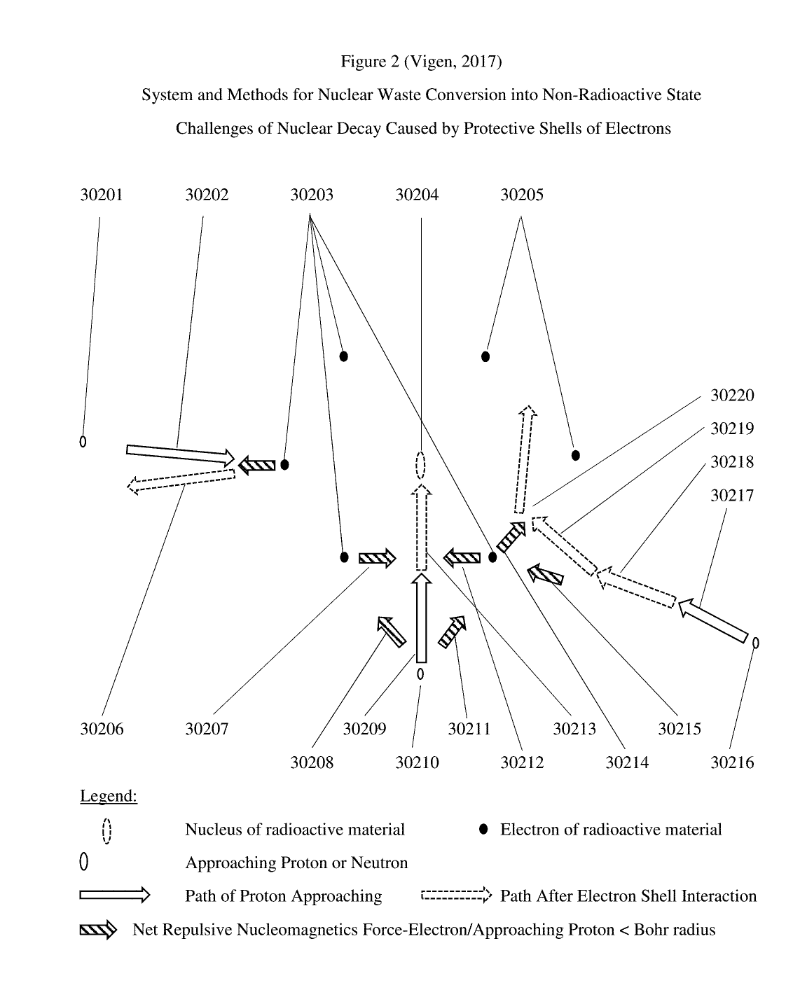

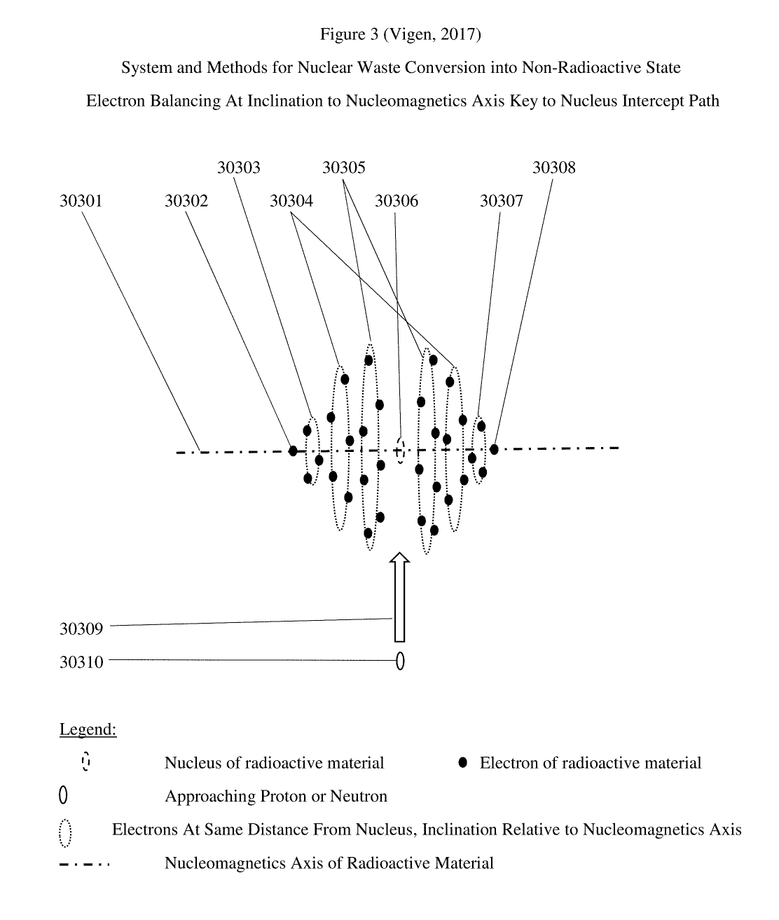

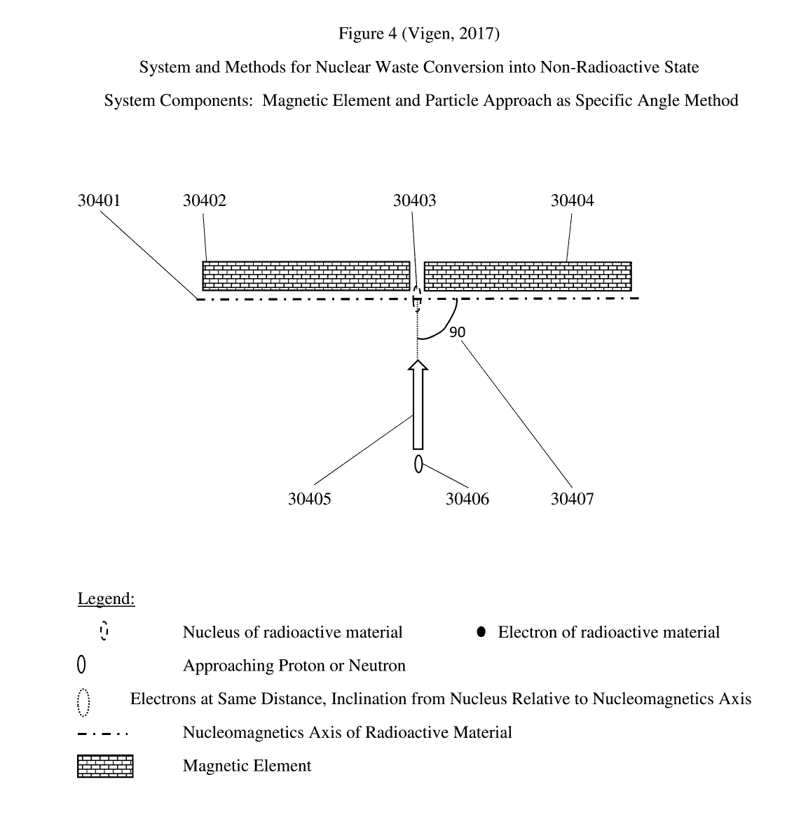

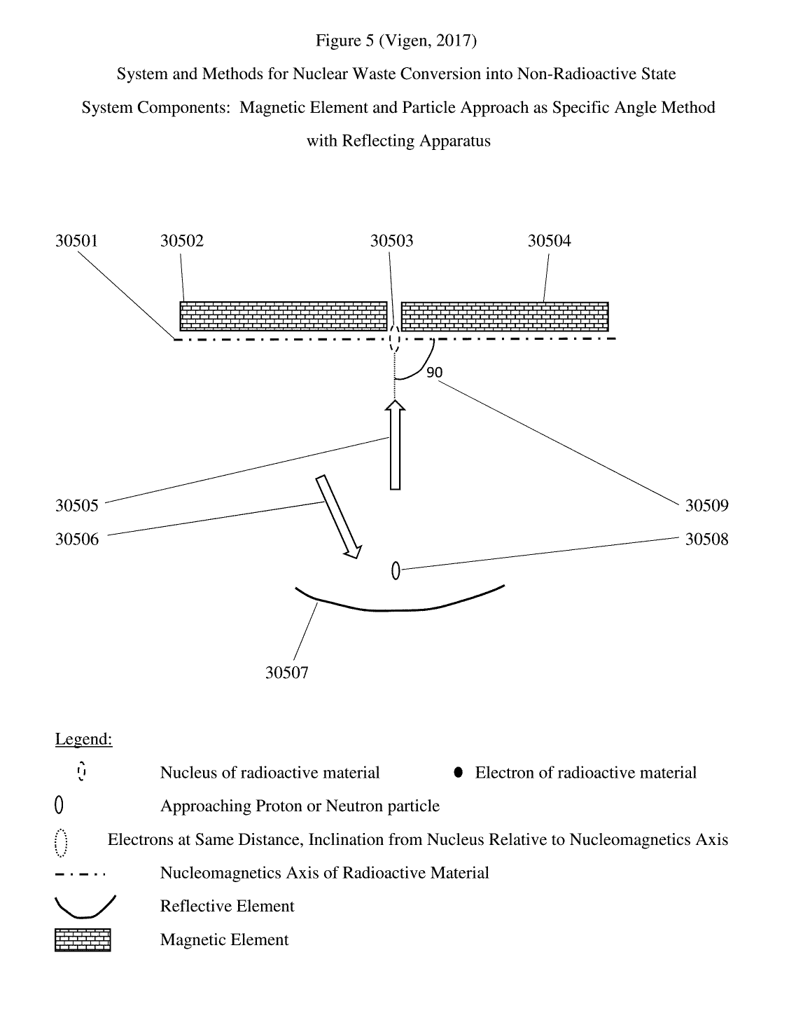

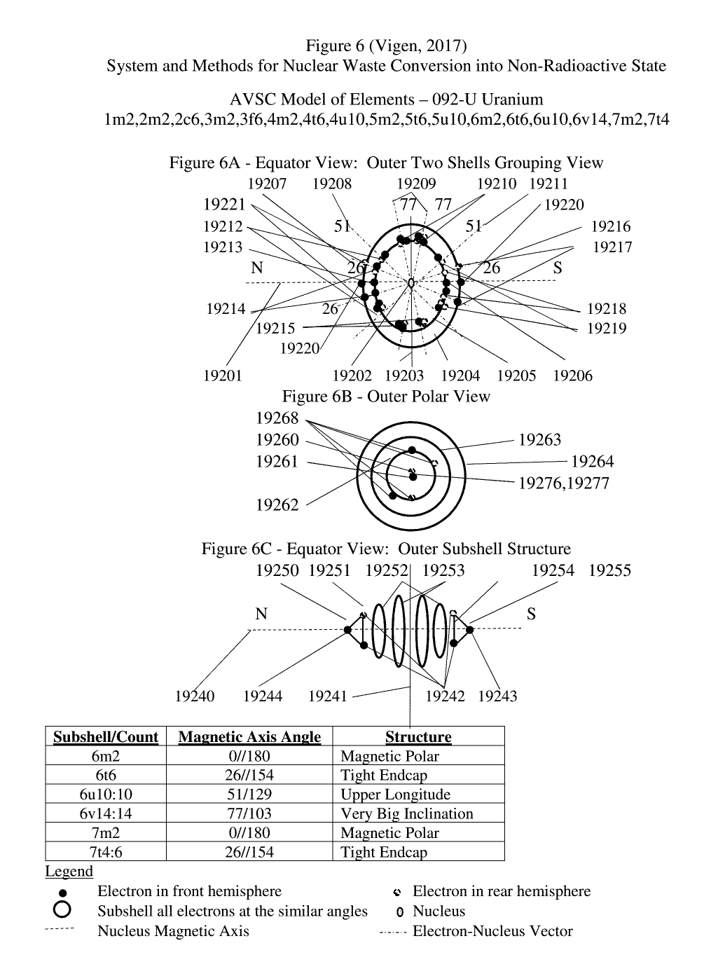

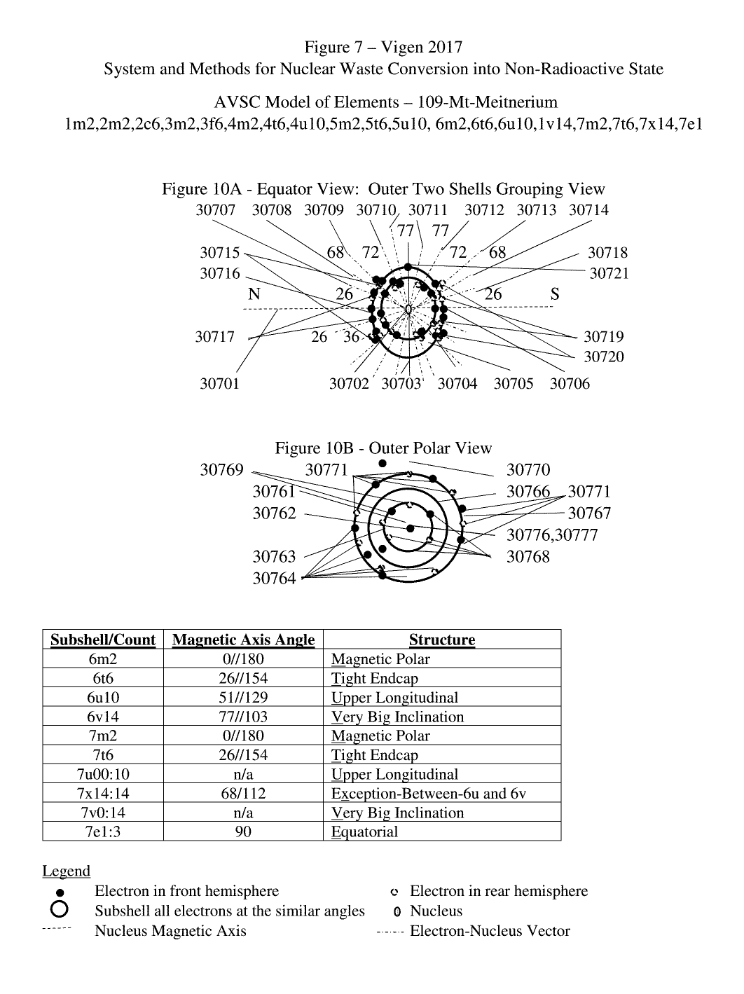

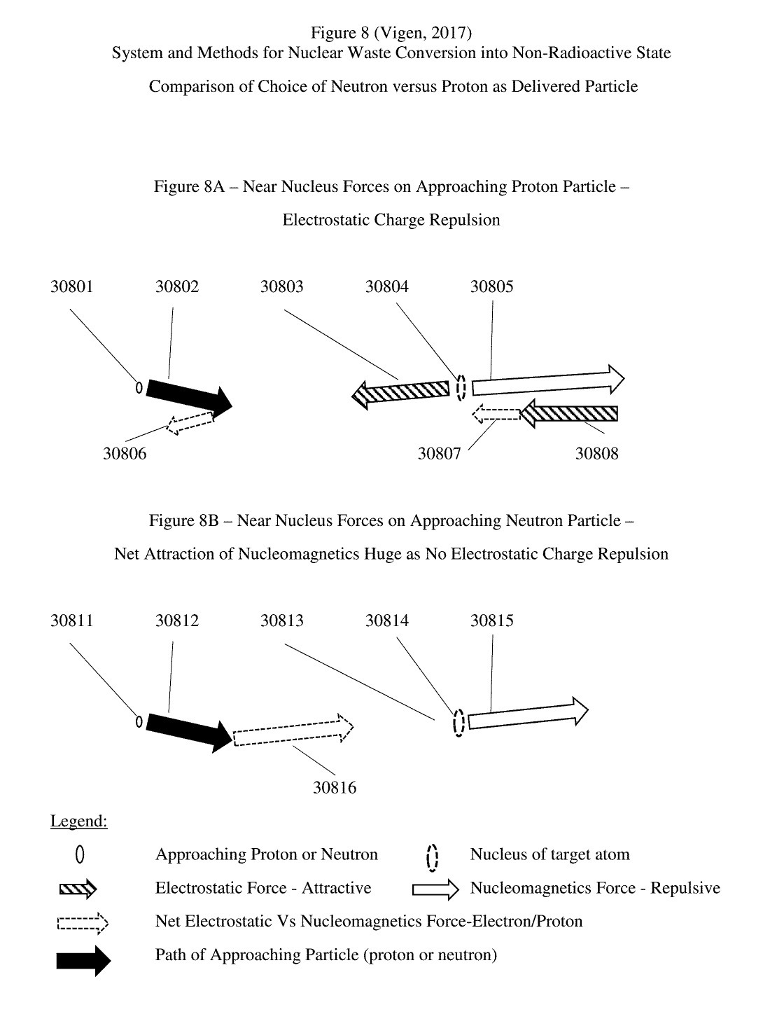

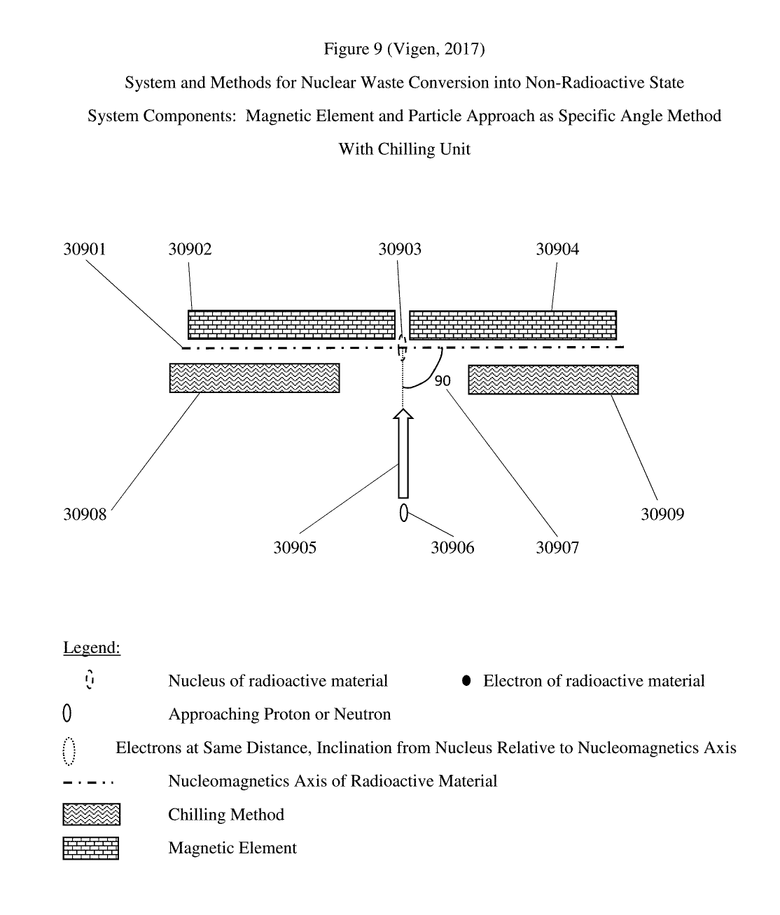

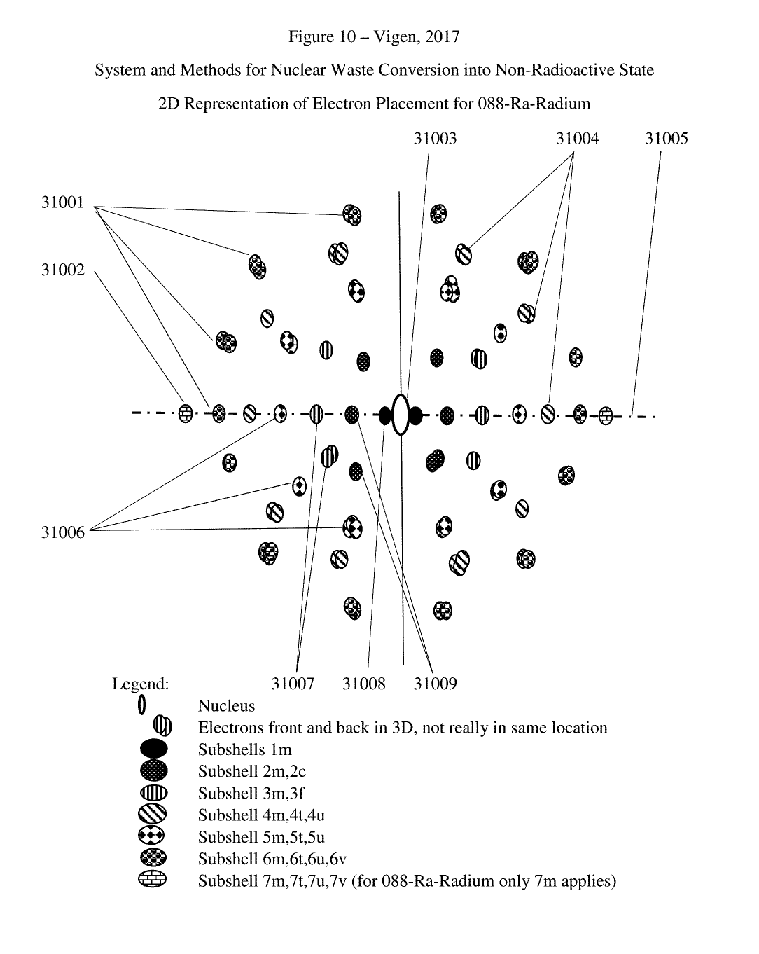

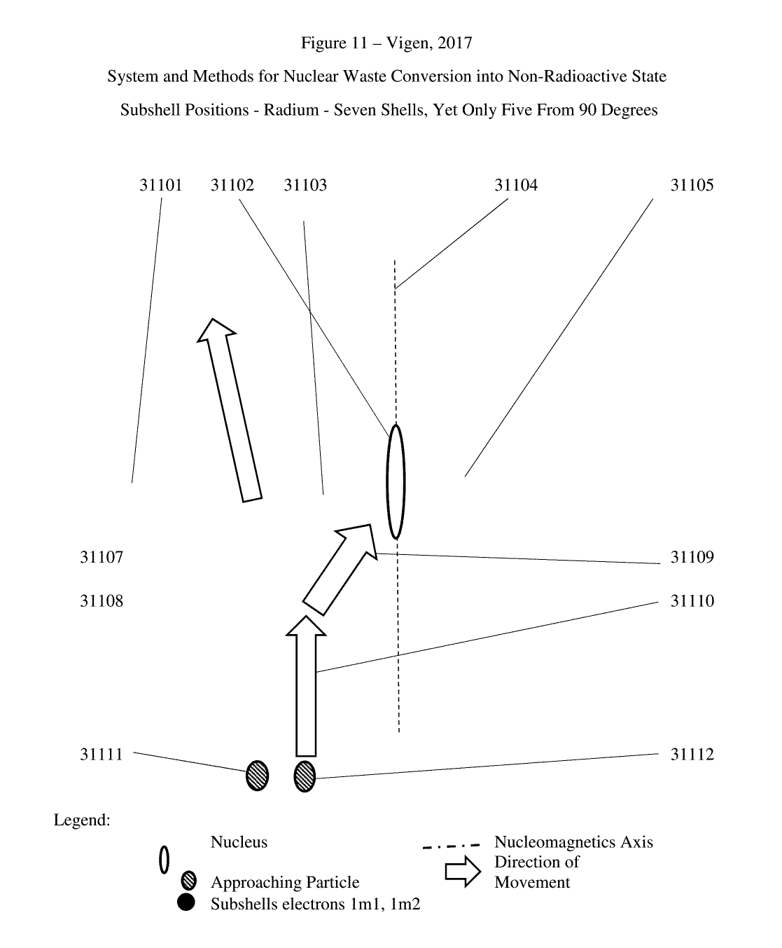

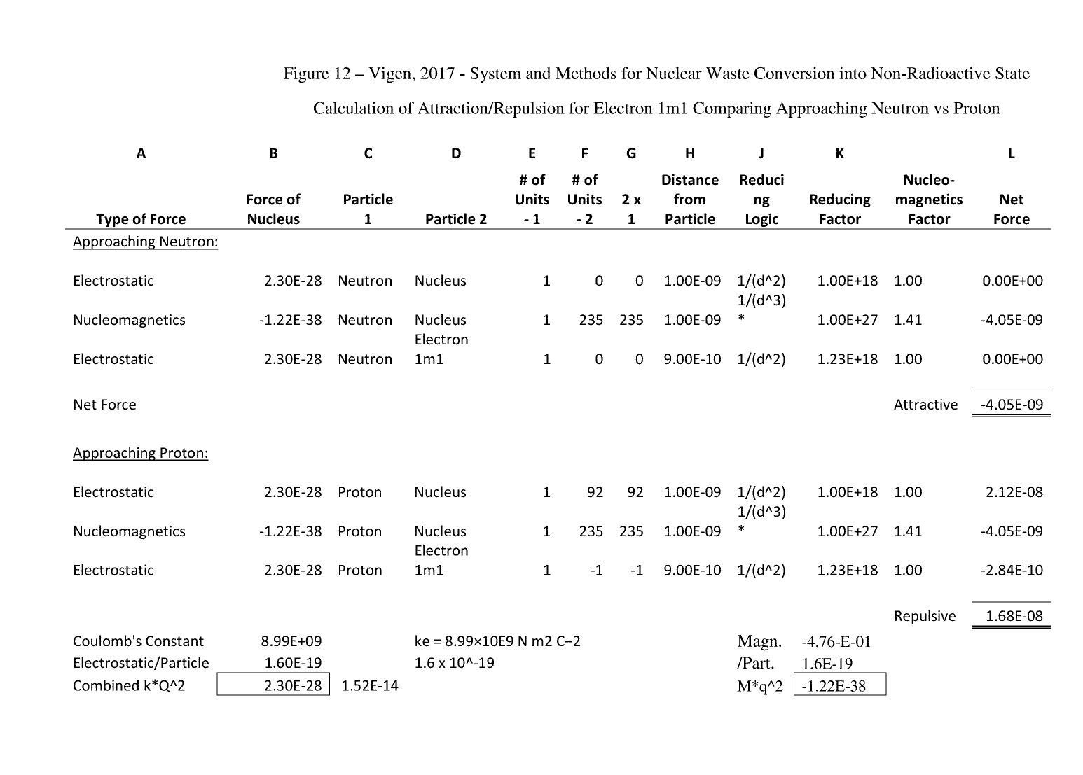

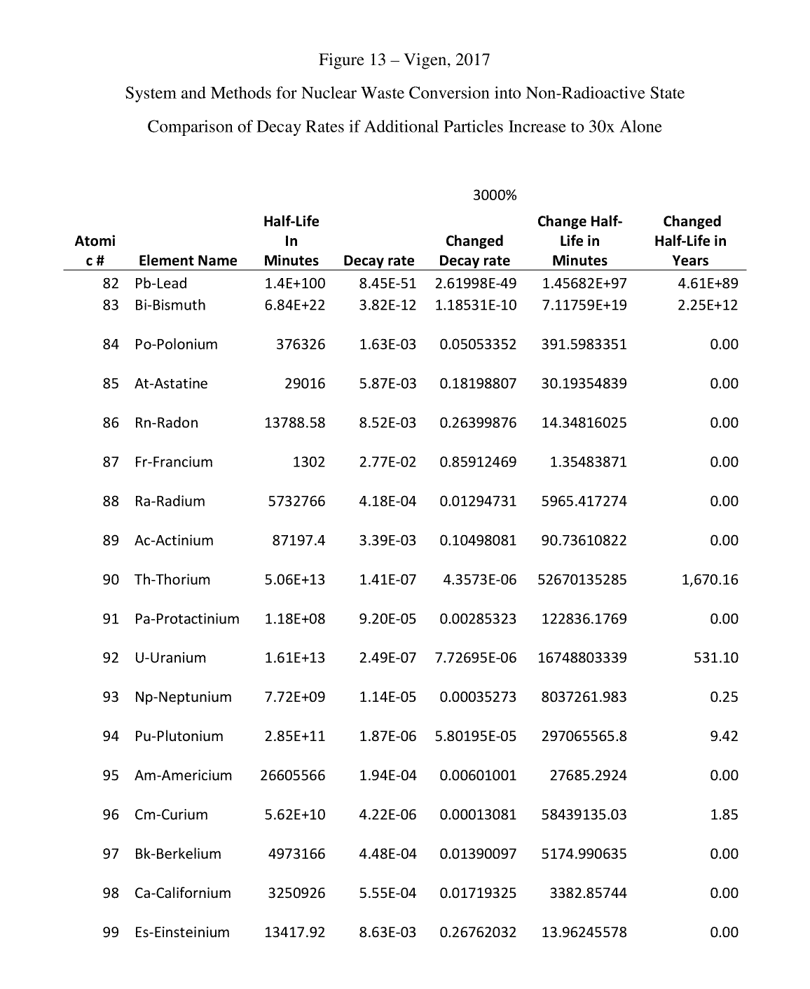

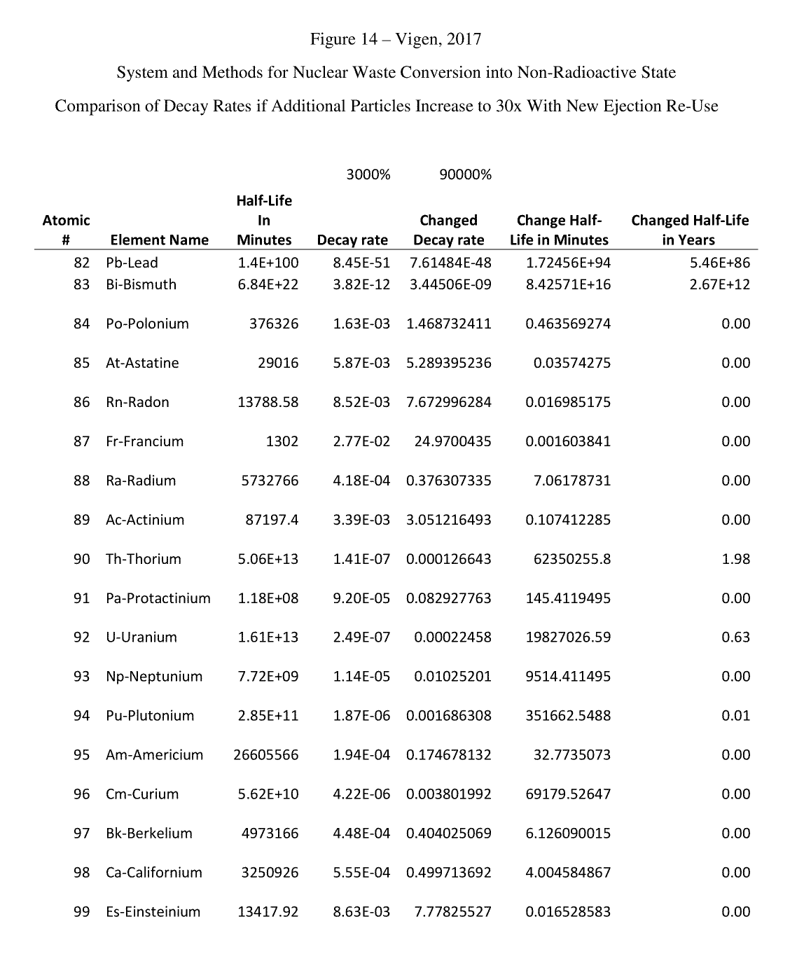

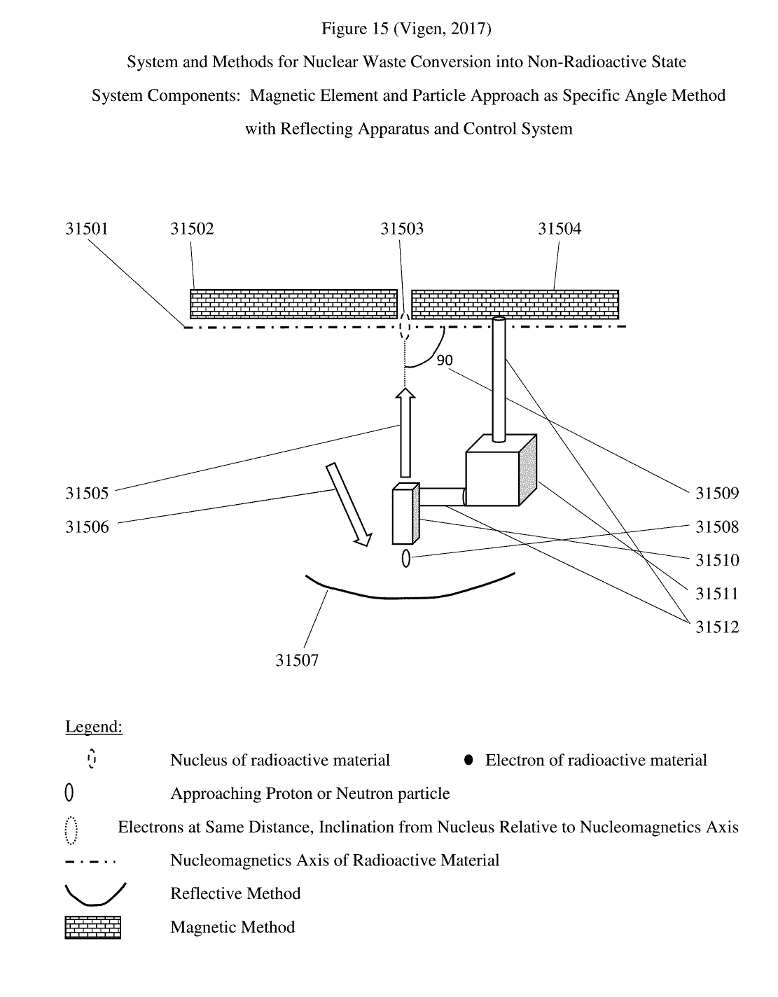

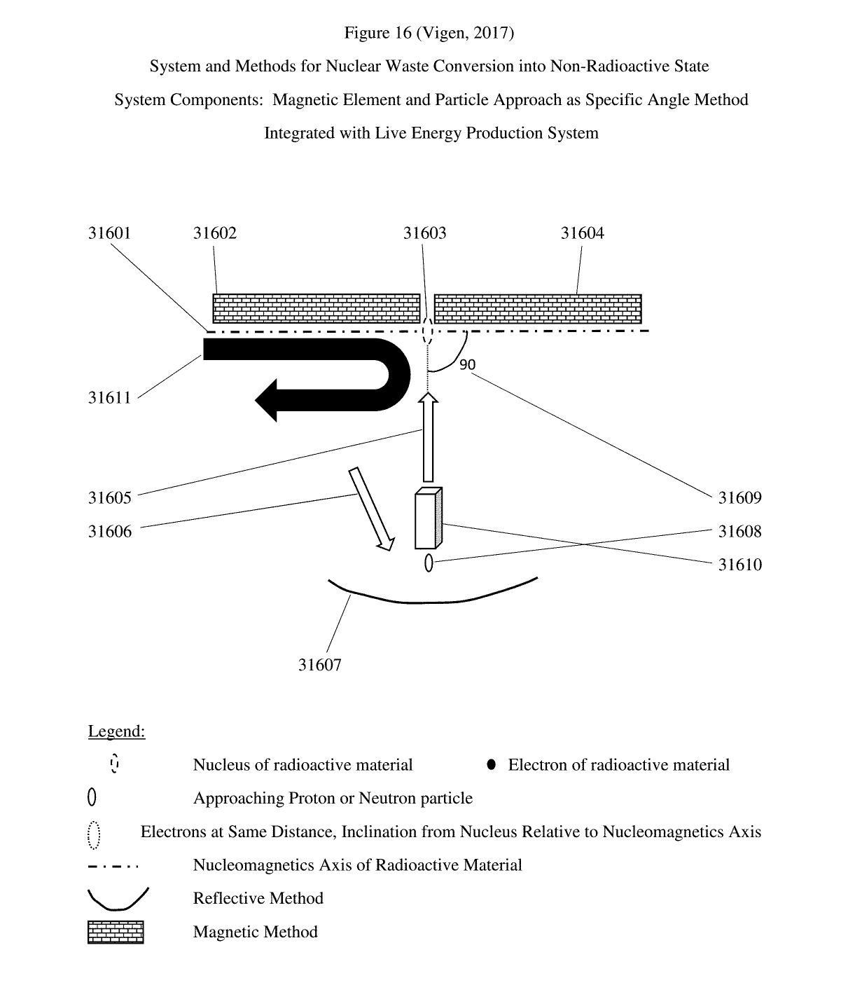

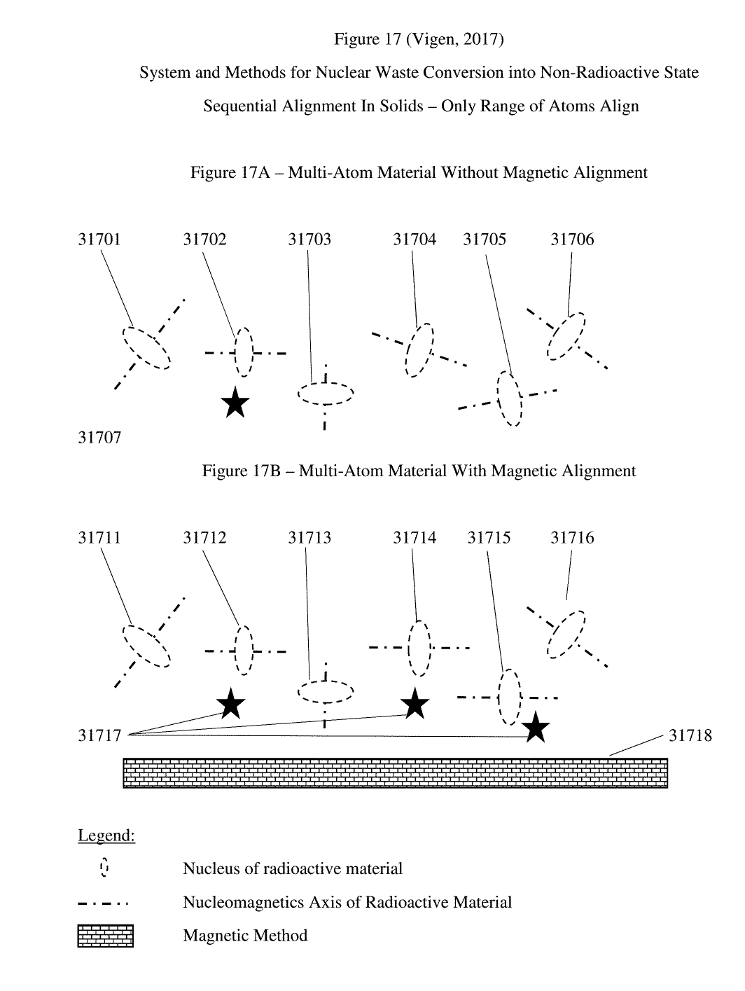

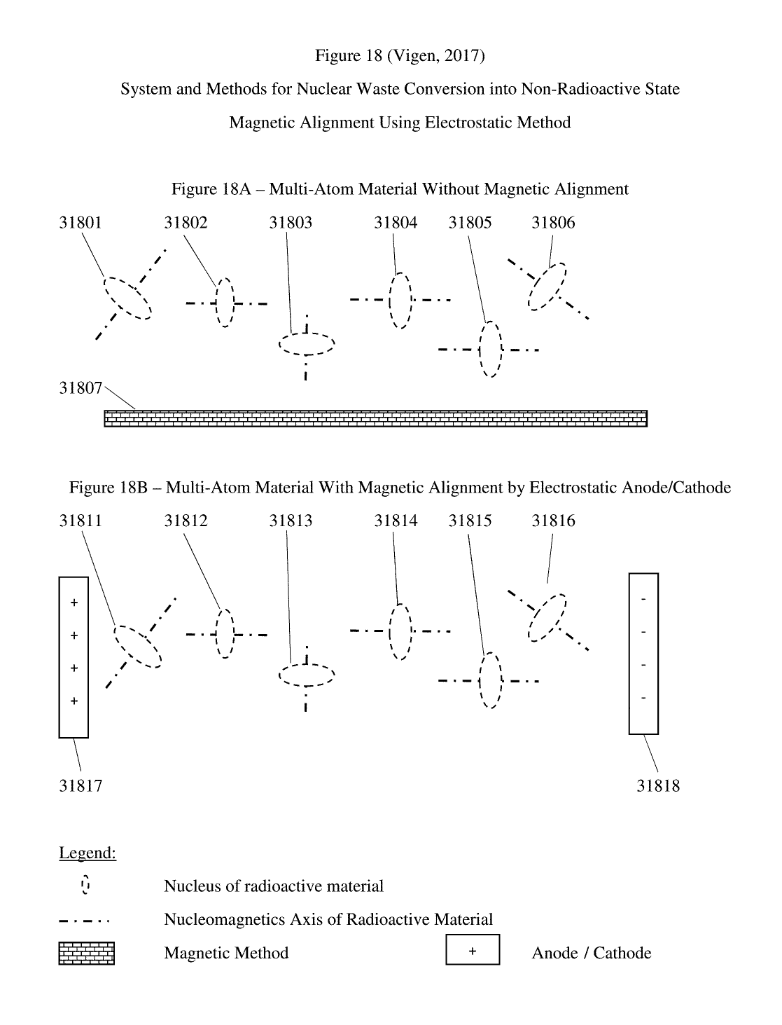

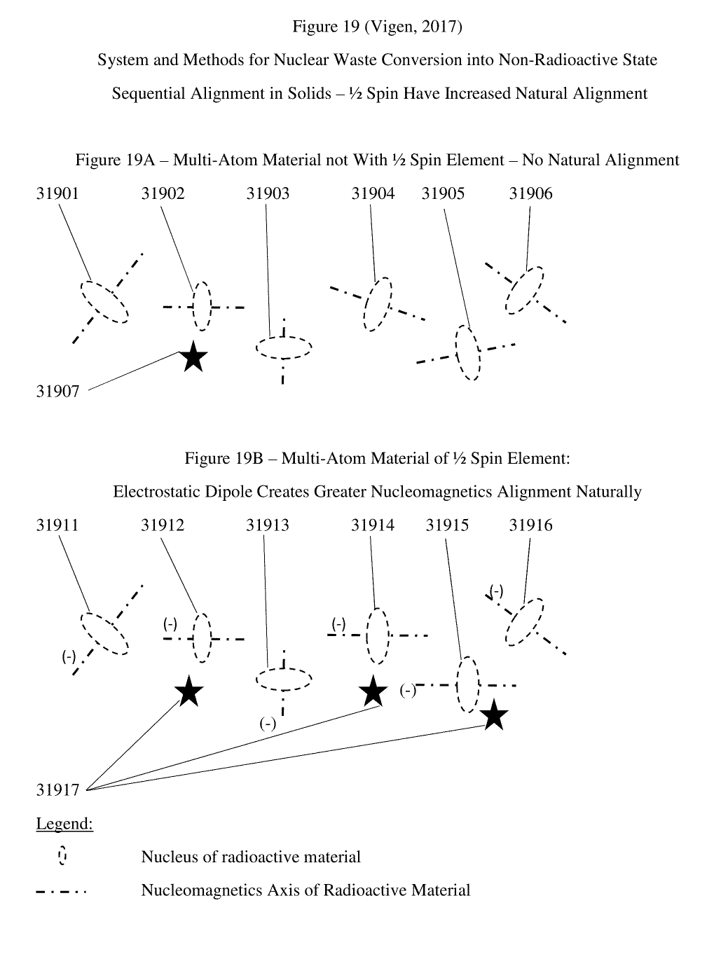

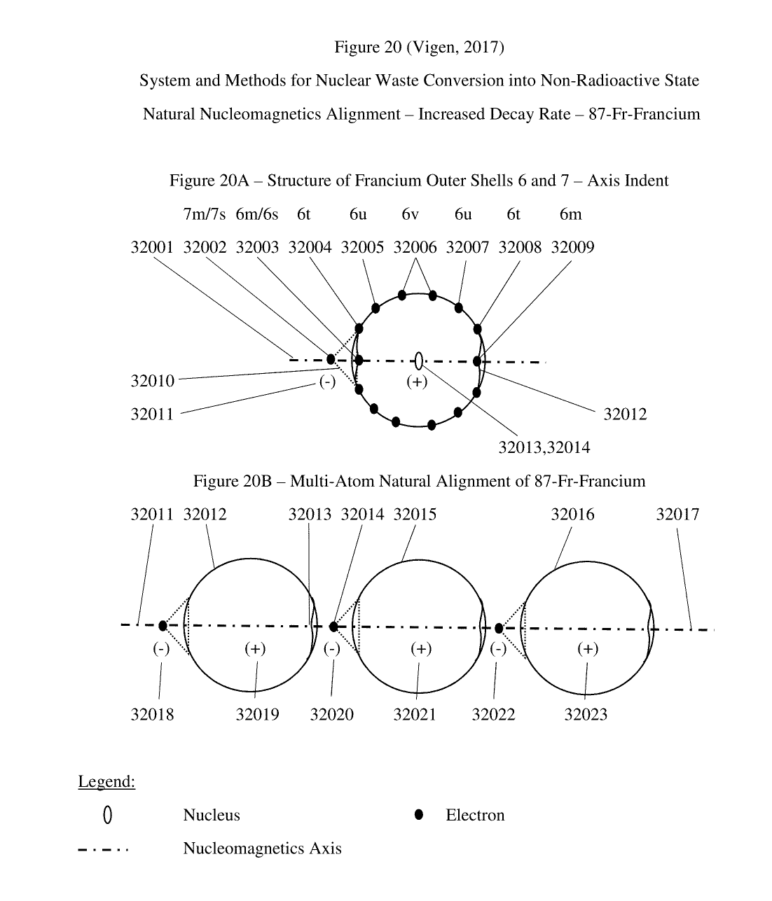

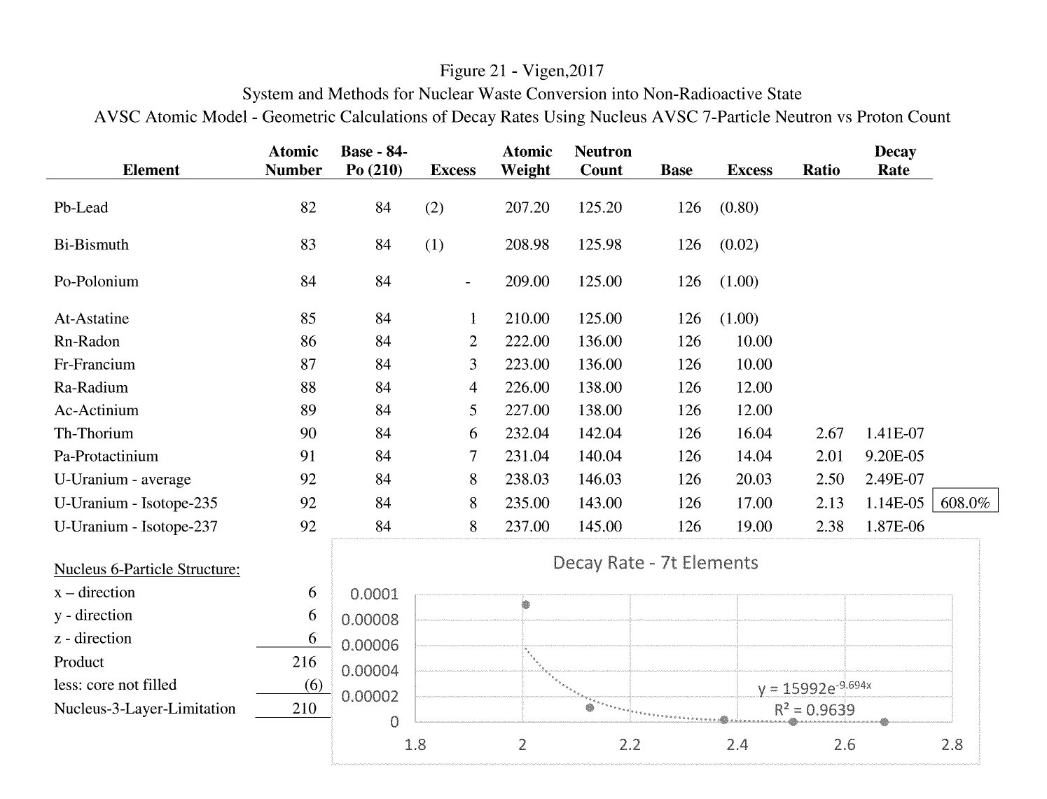

1. I claim:
a system consisting of:
a method to orient base physical material of a particular Periodic Chart Element relative to the magnetic axis of the atom's nucleus, or for multiple atoms, all or a subset of atoms;
a method to propel a particle, particles, or a grouping or groupings of particles at sufficient approach speed to pass a low-electron-deflection-energy channel in the electron shell into the nucleus;
a method to orient that approaching particle flow at an angle of inclination, calculated as the low-electron-deflection-energy channel for that Element, relative to the induced magnetic field axis of their aligned portion of the target material such that the path balances the forces of exterior electrons in a lower repulsion energy channel from exterior to the nucleus between the electrons and delivers said material to area of the target nucleus; and
this system is applied to create a change in the nucleus particle count of the target material.

2. Claim 1 where the preferred angle of attack is limited to a range +/−90 degrees relative to the induced magnetic field for target radioactive materials not one of the elements 095-Am-Americium, 096-Cm-Curium, 097-Bk-Berkelium, 109-Mt-Meitnerium, 110-Ds-Darmstadtium, and 111-Rg-Roentgenium.

3. Claim 1 where the temperature of the environment for the interaction is reduced so orientation improves.

4. Claim 3 and a method that includes braking of atomic bonds of the target material and causing atomic bonds to form in an environment with strong magnetic orientation.

5. I claim:
Claim 1 and where radioactive material uses a method to get atoms better aligned magnetically before use in its function, including but not limited to a crystallization process in the presence of a strong magnetic field.

6. I claim:
a system consisting of:
a method to orient base physical material of a particular Periodic Chart Element relative to the magnetic axis of the atom's nucleus, or for multiple atoms, all or a subset of atoms;
a method to propel a particle, particles, or a grouping or groupings of particles at sufficient approach speed to pass a low-electron-deflection-energy channel in the electron shell into the nucleus;
a method to orient that approaching particle flow at an angle of inclination, calculated as the low-electron-deflection-energy channel for that Element, relative to the induced magnetic field axis of their aligned portion of the target material such that the path balances the forces of exterior electrons in a lower repulsion energy channel from exterior to the nucleus between the electrons and delivers said material to area of the target nucleus; and
this system is applied to create a change in the nucleus particle count of the target material; and
where the combined orientation and particle delivery system is done in segments of angle, segments of time, or combinations thereof, such that atoms for a range of alignments are processed with the combination alignment and particle delivery, then the combination gets applied to a difference range of atom alignments.

7. Claim 1 where the events include a further material with high reflection properties of nucleus particles in combination with a focusing shape, including but not limited to a parabolic shape.

8. Claim 7 and the reflective material is ionized to create higher rate of particle reflection.

9. Claim 1 and a control systems measuring the output factors of the process to alter or stop the magnetics, angle, or those methods in combination.

10. Claim 1 and where the magnetic alignment occurs via an electrostatic charge method.

11. Claim 1 and where the system gets applied the radioactive material in another production process to extended life of the in-service resource.

12. Claim 11 and the rate of delivery of particles is increased as material decays such that output level remains sufficient for other operations deeper into the material's decay cycle.

13. Claim 1 and the deliver particles contain both neutrons and protons as a group.

14. Claim 1 and the angles are calculated to include more than one Element in the target material.

15. Claim 1 and where a method has been applied to the material to solidify in a crystallized structure.

16. Claim 15 and where the material preparation, including but not limited to crystallization, has been applied in the present of a strong magnetic field.

17. Claim 1 and where the target material has been prepared in the present of a strong electrostatic field, which achieves magnetic field alignment.

18. Claim 1 and a method where the target material is added, including but not limited to the method of doping, into a different material in crystal structure, including but not limited to material formed a cubic crystallized structure.

19. I claim:
a system consisting of:
a method to orient base physical material of a particular Periodic Chart Element relative to the magnetic axis of the atom's nucleus, or for multiple atoms, all or a subset of atoms;
a method to reflect or redirect from the radioactive material its output of a particle, particles, or a grouping or groupings of particles at sufficient approach speed to pass a low-electron-deflection-energy channel in the electron shell into the nucleus;
a method to orient that re-directed particle flow at an angle of inclination, calculated as the low-electron-deflection-energy channel for that Element, relative to the induced magnetic field axis of their aligned portion of the target material such that the path balances the forces of exterior electrons in a lower repulsion energy channel from exterior to the nucleus between the electrons and delivers said material to area of the target nucleus; and
this system is applied to create a change in the nucleus particle count of the target material.

20. Claim 19 and the reflection method is ionized to create additional negative charges that reflect additional particles.
